(19) United States
(12) Patent Application Publication
(10) Pub. No.: US 2026/0172934 A1
(43) Pub. Date: Jun. 18, 2026

(54) NODE IN WIRELESS COMMUNICATION SYSTEM AND METHOD PERFORMED BY THE SAME

(71) Applicant: Samsung Electronics Co., Ltd., Gyeonggi-do (KR)

(72) Inventors: Yanru WANG, Beijing (CN); Hong WANG, Beijing (CN); Lixiang XU, Beijing (CN)

(21) Appl. No.: 19/125,406

(22) PCT Filed: Nov. 2, 2023
(86) PCT No.: PCT/KR2023/017408

§ 371 Date: Apr. 29, 2025

(30) Foreign Application Priority Data
Nov. 2, 2022 (CN) 202211364789.X
Aug. 4, 2023 (CN) 202310982077.2

(51) Int. Cl. H04W 36/16; H04W 36/36; H04W 52/02

(52) U.S. Cl. CPC H04W 36/165; H04W 36/362; H04W 52/0206

(57) ABSTRACT

The disclosure relates to a 5G or 6G communication system for supporting a higher data transmission rate. The present 2024/096627 disclosure provides a node in a wireless communication system and a method performed by the same. A method performed by a second node in a wireless communication system according to embodiments of the present disclosure may include: receiving a second message including information about measurement relaxation from a first node; and transmitting a seventh message including a reference signal transmission suggestion to a third node.

### TECHNICAL FIELD

The present disclosure relates to a technical field of wireless communication, and more specifically, to a node in a wireless communication system and a method performed by the same.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The existing technology does not support various forms of energy-saving, so an enhanced method is needed to support various forms of energy-saving.

### DISCLOSURE OF INVENTION

### Technical Problem

The present disclosure relates to wireless communication systems and, more specifically, the invention relates to node in wireless communication system and method performed by the same.

### Solution to Problem

Embodiments of the present disclosure provide a method performed by a second node in a wireless communication system, including: receiving a second message including information about measurement relaxation from a first node; and transmitting a seventh message including a reference signal transmission suggestion to a third node.

According to embodiments of the present disclosure, the method performed by the second node in the wireless communication system further includes: transmitting a first message including a request for the information about measurement relaxation to the first node.

According to embodiments of the present disclosure, the method performed by the second node in the wireless communication system further includes: transmitting a third message including a configuration about measurement relaxation to the first node, wherein the configuration about measurement relaxation is configured based on the information about measurement relaxation.

According to embodiments of the present disclosure, the method performed by the second node in the wireless communication system further includes: receiving a fifth message including handover time information of a target node from a fourth node.

According to embodiments of the present disclosure, the method performed by the second node in the wireless communication system further includes: transmitting a fourth message including handover time information of a source node to the fourth node.

According to embodiments of the present disclosure, the method performed by the second node in the wireless communication system further includes: transmitting a radio resource control reconfiguration message to the first node based on the handover time information of the target node.

According to embodiments of the present disclosure, the method performed by the second node in the wireless communication system further includes: transmitting a sixth message including handover configuration effective information to the first node.

According to embodiments of the present disclosure, the handover configuration effective information is received by the second node from a fourth node.

According to embodiments of the present disclosure, the method performed by the second node in the wireless communication system further includes: receiving an eighth message including a reference information transmission configuration from the third node.

According to embodiments of the present disclosure, the reference signal transmission suggestion is based on the information about measurement relaxation.

According to embodiments of the present disclosure, the first message includes one or more of the following: request identification of information about measurement relaxation, applicable scope of information about measurement relaxation requested to be reported, reporting registration request, reporting mode, trigger event, reporting interval, reporting time, reporting request of predicted information about measurement relaxation and content requested to be reported.

According to embodiments of the present disclosure, the second message includes one or more of the following: reported content, event triggering the reporting; and/or the seventh message includes one or more of the following: applicable scope of a configuration about measurement relaxation and a suggested reference signal transmission configuration.

According to embodiments of the present disclosure, the third message includes one or more of the following: applicable scope of a configuration about measurement relaxation and configuration content of measurement relaxation.

According to embodiments of the present disclosure, the fourth message includes one or more of the following: applicable scope of a configuration about measurement relaxation, predicted handover time and acceptable handover time.

According to embodiments of the present disclosure, the fifth message includes one or more of the following: applicable scope of a configuration about measurement relaxation and handover time.

According to embodiments of the present disclosure, the sixth message includes one or more of the following: applicable scope of a configuration about measurement relaxation, effective time of an execution condition, effective time of a configuration and an execution condition.

According to embodiments of the present disclosure, the eighth message includes one or more of the following: applicable scope of a configuration about measurement relaxation, acceptance and/or rejection of a reference signal transmission suggestion, and a reference signal transmission configuration.

Embodiments of the present disclosure provides a method performed by a first node in a wireless communication system, which includes: transmitting a second message including information about measurement relaxation to a second node, wherein the information about measurement relaxation is used to generate a seventh message including a reference signal transmission suggestion.

Embodiments of the present disclosure provides a node device in a wireless communication system, including: a transceiver configured to transmit and receive signals; and a controller coupled with the transceiver and configured to perform the methods performed by a first node and/or a second node in a wireless communication system according to embodiments of the present disclosure.

Embodiments of the present disclosure provide a computer-readable medium having stored thereon computer-readable instructions which, when executed by a processor, are used to implement the methods performed by a first node and/or a second node in a wireless communication system according to embodiments of the present disclosure.

The methods performed by a first node and/or a second node in a wireless communication system provided by the present disclosure can enable the nodes to optimize or update the configuration by exchanging energy-saving related information such as information about measurement relaxation among the nodes, thereby achieving a purpose of energy-saving.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 is an exemplary system architecture 100 of system architecture evolution (SAE);

FIG. 2 is an exemplary system architecture 200 according to various embodiments of the present disclosure;

FIG. 3A illustrates a schematic diagram of an aspect of a method for supporting network energy-saving according to embodiments of the present disclosure;

FIG. 3B illustrates a schematic diagram of an aspect of a method for supporting network energy-saving according to embodiments of the present disclosure;

FIG. 3C illustrates a schematic diagram of an aspect of a method for supporting network energy-saving according to embodiments of the present disclosure;

FIG. 3D illustrates a schematic diagram of an aspect of a method for supporting network energy-saving according to embodiments of the present disclosure;

FIG. 4A illustrates a schematic diagram of an aspect of a method for supporting network energy-saving according to embodiments of the present disclosure;

FIG. 4B illustrates a schematic diagram of an aspect of a method for supporting network energy-saving according to embodiments of the present disclosure;

FIG. 4C illustrates a schematic diagram of an aspect of a method for supporting network energy-saving according to embodiments of the present disclosure;

FIG. 5A illustrates a schematic diagram of an aspect of a method for supporting network energy-saving according to embodiments of the present disclosure;

FIG. 5B illustrates a schematic diagram of an aspect of a method for supporting network energy-saving according to embodiments of the present disclosure;

FIG. 5C illustrates a schematic diagram of an aspect of a method for supporting network energy-saving according to embodiments of the present disclosure;

FIG. 5D illustrates a schematic diagram of an aspect of a method for supporting network energy-saving according to embodiments of the present disclosure;

FIG. 5E illustrates a schematic diagram of an aspect of a method for supporting network energy-saving according to embodiments of the present disclosure;

FIG. 6A illustrates a schematic diagram of an aspect of a method for supporting network energy-saving according to embodiments of the present disclosure;

FIG. 6B illustrates a schematic diagram of an aspect of a method for supporting network energy-saving according to embodiments of the present disclosure;

FIG. 6C illustrates a schematic diagram of an aspect of a method for supporting network energy-saving according to embodiments of the present disclosure;

FIG. 6D illustrates a schematic diagram of an aspect of a method for supporting network energy-saving according to embodiments of the present disclosure;

FIG. 6E illustrates a schematic diagram of an aspect of a method for supporting network energy-saving according to embodiments of the present disclosure;

FIG. 6F illustrates a schematic diagram of an aspect of a method for supporting network energy-saving according to embodiments of the present disclosure;

FIG. 7A illustrates a schematic diagram of an aspect of a method for supporting network energy-saving according to embodiments of the present disclosure;

FIG. 7B illustrates a schematic diagram of an aspect of a method for supporting network energy-saving according to embodiments of the present disclosure;

FIG. 8A illustrates a schematic diagram of an aspect of a method for supporting network energy-saving according to embodiments of the present disclosure;

FIG. 8B illustrates a schematic diagram of an aspect of a method for supporting network energy-saving according to embodiments of the present disclosure;

FIG. 8C illustrates a schematic diagram of an aspect of a method for supporting network energy-saving according to embodiments of the present disclosure;

FIG. 9 illustrates a flowchart of a method performed by a second node in a wireless communication system according to embodiments of the present disclosure;

FIG. 10 illustrates a flowchart of a method performed by a first node in a wireless communication system according to embodiments of the present disclosure;

FIG. 11 illustrates a schematic diagram of a first node according to embodiments of the present disclosure; and

FIG. 12 illustrates a schematic diagram of a second node according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

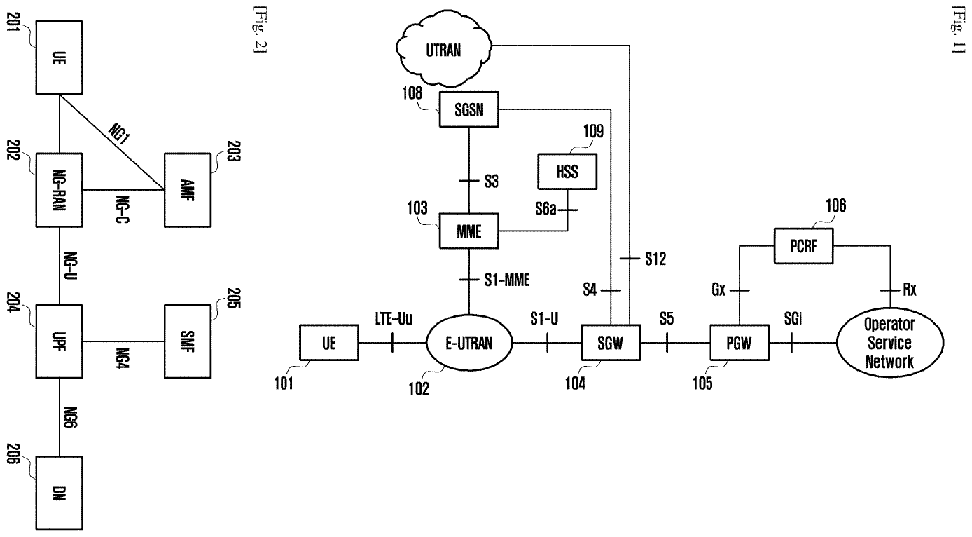

FIGS. 1 to 12 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Nodes and/or entities mentioned in the present disclosure may include gNB, gNB Central Unit (gNB CU), gNB Distributed Unit (gNB DU), gNB CU-Control Plane (gNB CU-CP), gNB CU-User Plane (gNB CU-UP), en-gNB, eNB, ng-eNB, UE, Access and Mobility Management Function (AMF), Session Management Function (SMF), Mobility Management Entity (MME) and other network nodes or network logic units, etc.

The signal strength and/or signal quality mentioned in the present disclosure may be Received Signal Strength Indicator (RSSI), Reference Signal Receiving Power (RSRP), Reference Signal Receiving Quality (RSRQ), Signal to Interference plus Noise Ratio (SINR), etc.

The methods performed by a first node and/or a second node in a wireless communication system according to embodiments of the present disclosure will be further described from various aspects in conjunction with specific examples. More generally, a method performed by a first node and/or a second node in a wireless communication system according to embodiments of the present disclosure may also be called a method for supporting network energy-saving.

### EXAMPLE 1

An example of the present disclosure proposes a method for supporting network energy-saving, which may include: when a UE is moving at a low speed and/or a channel quality is good, the UE may relax a measurement criterion, for example, increase a measurement interval, and reduce reference signals measured.

A second node transmits a first message containing a Measurement Relaxation information reporting request to a first node, so as to request the first node to transmit information about measurement relaxation of the first node and/or other nodes to the second node, so as to provide reference information for the second node to make a network energy-saving decision. Herein, the other nodes may be any network node except the first node.

In some implementations, the first message may be one or more of the following: an RRCReconfiguration message or an RRCReestablishment message or an RRCSetup message or an RRCRelease message of Radio Resource Control (RRC); or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; or an other and/or newly defined RRC and/or Xn and/or X2 and/or F1 and/or E1 and/or NG message.

In some implementations, the first message may include one or more of the following fields and/or related information:
transmitting node identification: identification of the node that transmits the first message.
receiving node identification: identification of the node that receives the first message.
request identification of information about measurement relaxation: used to identify that the request is a request to report information about measurement relaxation, and/or to indicate whether information about measurement relaxation needs to be reported. It may be indicated by a single bit. For example, when the bit is 1, it indicates that information about measurement relaxation is requested to be reported and/or information about measurement relaxation needs to be reported, and when the bit is 0, it indicates that information about measurement relaxation is not requested to be reported and/or information about measurement relaxation needs not to be reported; alternatively, when the bit is 0, it indicates that information about measurement relaxation is requested to be reported and/or information about measurement relaxation needs to be reported, and when the bit is 1, it indicates that information about measurement relaxation is not requested to be reported and/or information about measurement relaxation needs not to be reported.
applicable scope of information about measurement relaxation requested to be reported: it may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc. The information about measurement relaxation may be current information about measurement relaxation or predicted information about measurement relaxation.
reporting registration request: used to indicate the start, end, addition, etc. of a reporting.
reporting mode: used to indicate the mode of a reporting, for example, it may include event-triggered, On-demand, single reporting, periodic reporting, etc.
trigger event: used to indicate the event that triggers a reporting, for example, it may be one or more of the following: the measurement relaxation starts, the measurement relaxation is predicted to be performed, the measurement relaxation ends, the measurement relaxation is predicted to be ended, the UE starts to move at a low speed, the UE is stationary, the signal quality is good, the signal quality is good for a long time, etc.
reporting interval/period/periodicity: used to indicate the reporting interval of a periodic reporting.
reporting time: used to indicate the reporting time information of a reporting. For example, it may be the start time and/or the end time of the reporting.
reporting request of predicted information about measurement relaxation:
   reporting mode of the requested predicted information about measurement relaxation: used to indicate the mode for reporting the requested predicted information about measurement relaxation, which may include, for example, event-triggered, On-demand, single reporting, periodic reporting, etc.
   reporting registration request of the requested predicted information about measurement relaxation: used to indicate the start, end, addition, etc. of the reporting of the requested predicted information about measurement relaxation.
   reporting interval of the requested predicted information about measurement relaxation: used to indicate the reporting interval of the requested periodic reporting of the predicted measurement relaxation.
   reporting time information of the requested predicted information about measurement relaxation: used to indicate the time information of the requested predicted information about measurement relaxation.
   applicable/validity time of the predicted information about measurement relaxation that is requested for reporting: used to indicate the applicable/validity time point and/or applicable/validity time period of the predicted information about measurement relaxation that is requested for reporting. This time may be a relative time or an absolute time. If it is a time interval, it may be indicated by 2*n bits, for example, the first n bits indicate a start time and the last n bits indicate an end time. Or it may be indicated by separate fields, including one or more of the following:
      start time: used to indicate a start time. The starting time may be a relative time or an absolute time.
      end time: used to indicate an end time. The end time may be a relative time or an absolute time.
content requested to be reported: used to indicate the content requested to be reported. The content may be a current content or a predicted content. The content may include one or more of the following:
   start of the measurement relaxation
   start time of the measurement relaxation
   end of the measurement relaxation
   end time of the measurement relaxation
   signal type for measurement relaxation, which may include one or more of the following: SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal. Herein, the Radio Link Monitoring Reference Signal may include one or more of the following: Synchronization Signal Block (SSB), Channel-State Information (CSI) reference signal, and a combination/mix of SSB and CSI-RS; and the Beam Failure Detection reference signal may include CSI-RS.
   measurement period
   measurement interval
   measured reference signal, which may include one or more of the following: SSB, CSI-RS, Demodulation Reference Signal (DMRS), Sounding Reference Signal (SRS), Phase-tracking reference signals (PTRS), etc.
   satisfied criterion, which may include one or more of the following: low-speed movement, good signal quality, etc.
   frequency information, which may include one or more of the following: BWP, central frequency, frequency hopping information, etc.

In some implementations, the first node may transmit a second message containing information about measurement relaxation of the first node and/or other nodes to the second node according to its own situation (for example, autonomously) and/or according to the received first message containing a reporting request for information about measurement relaxation (for example, measurement relaxation information reporting request), for the second node to obtain the information about measurement relaxation of the first node and/or other nodes for network energy-saving configuration update and/or self-optimization decision, etc. For example, when receiving the information about measurement relaxation of a UE, the second node may adjust an energy-saving strategy according to the information about measurement relaxation of the UE. For example, if the UE only measures a part of reference signals, the node may reduce transmission of reference signals that the UE does not measure (for example, signals of measurement relaxation). For example, if the UE extends the measurement interval, the node may extend the transmission interval of reference signals, to achieve a purpose of energy-saving.

In some implementations, the second message may be one or more of the following: a MEASUREMENT REPORT message of RRC; or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; or an other and/or newly defined RRC and/or Xn and/or X2 and/or F1 and/or E1 and/or NG message.

In some implementations, the second message may include one or more of the following fields and/or related information:
transmitting node identification: identification of the node that transmits the second message.
receiving node identification: identification of the node that receives the second message.
reported content: which indicates the reported content. This content may be a current content or a predicted content. It may include one or more of the following:
   applicable scope: the scope corresponding to the information about measurement relaxation, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
   start of the measurement relaxation
   start time of the measurement relaxation
   end of the measurement relaxation
   end time of the measurement relaxation
   signal type for measurement relaxation, which may include one or more of the following: SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal. Herein, the Radio Link Monitoring Reference Signal may include one or more of the following: Synchronization Signal Block (SSB), Channel-State Information (CSI) reference signal, and a combination/mix of SSB and CSI-RS; and the Beam Failure Detection reference signal may include CSI-RS.
   measurement period
   measurement interval
   measured reference signal, which may include one or more of the following: SSB, CSI-RS, Demodulation Reference Signal (DMRS), Sounding Reference Signal (SRS), Phase-tracking reference signals (PTRS), etc.
frequency information, which may include one or more of the following: BWP, central frequency, frequency hopping information, etc.
satisfied criterion, which may include one or more of the following: low-speed movement, good signal quality, etc.
predicted applicable/validity time corresponding to the information about measurement relaxation: used to indicate a predicted applicable/validity time point and/or applicable/validity time period of the information about measurement relaxation. This time may be a relative time or an absolute time. If it is a time interval, it may be indicated by 2*n bits, for example, the first n bits indicate a start time and the last n bits indicate an end time. Or it may be indicated by separate fields, including one or more of the following:
   start time: used to indicate a start time. The starting time may be a relative time or an absolute time.
   end time: used to indicate an end time. The end time may be a relative time or an absolute time.
event triggering the reporting: used to indicate an event that triggers the reporting, for example, it may be one or more of the following: the measurement relaxation starts, the measurement relaxation is predicted to be performed, the measurement relaxation ends, the measurement relaxation is predicted to be ended, the UE starts to move at a low speed, the UE is stationary, the signal quality is good, the signal quality is good for a long time, etc.

### EXAMPLE 2

An example of the present disclosure proposes a method for supporting network energy-saving, which may include: a second node transmits a third message containing a configuration about measurement relaxation to a first node, in order for the first node and/or other nodes to perform a relaxed measurement according to the configuration to unify the configuration about measurement relaxation, and the nodes may reasonably configure the transmission configuration (such as transmission type, transmission time interval, and the like) of reference signals according to the unified configuration about measurement relaxation. Herein, the other nodes may be any network node except the first node.

In some implementations, the third message may be one or more of the following: an RRCReconfiguration message or an RRCReestablishment message or an RRCSetup message or an RRCRelease message of Radio Resource Control (RRC); or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the third message may include one or more of the following fields and/or related information:
transmitting node identification: identification of the node that transmits the third message.
receiving node identification: identification of the node that receives the third message.
applicable scope: a scope corresponding to the configuration about measurement relaxation, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
configuration content of measurement relaxation: this configuration may be a configuration for the present, or a configuration for a certain time in the future, or a predicted configuration. It may include one or more of the following:
   start of the measurement relaxation
   start time of the measurement relaxation
   end of the measurement relaxation
   end time of the measurement relaxation
   signal type for measurement relaxation, which may include one or more of the following: SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal. Herein, the Radio Link Monitoring Reference Signal may include one or more of the following: Synchronization Signal Block (SSB), Channel-State Information (CSI) reference signal, and a combination/mix of SSB and CSI-RS; and the Beam Failure Detection reference signal may include CSI-RS.
   measurement period
   measurement interval
   measured reference signal, which may include one or more of the following: SSB, CSI-RS, Demodulation Reference Signal (DMRS), Sounding Reference Signal (SRS), Phase-tracking reference signals (PTRS), etc.
   frequency information, which may include one or more of the following: BWP, central frequency, frequency hopping information, etc.
   criterion for making the configuration effective, which may include one or more of the following: low-speed movement, good signal quality, etc. When the criterion is satisfied, the configuration about measurement relaxation takes effect.
   predicted applicable/validity time corresponding to the information about measurement relaxation: used to indicate a predicted applicable/validity time point and/or applicable/validity time period of the information about measurement relaxation. This time may be a relative time or an absolute time. If it is a time interval, it may be indicated by 2*n bits, for example, the first n bits indicate a start time and the last n bits indicate an end time. Or it may be indicated by separate fields, including one or more of the following:
      start time: used to indicate a start time. The starting time may be a relative time or an absolute time.
      end time: used to indicate an end time. The end time may be a relative time or an absolute time.

### EXAMPLE 3

An example of the present disclosure proposes a method for supporting network energy-saving, which may include: a third node transmits a fourth message containing handover time information of a source side (e.g., source node) to a fourth node for the fourth node and/or other nodes to make handover action and/or make handover strategies and the like according to the provided handover time of the source side. Herein, the other nodes may be any network node except the fourth node.

In some implementations, the fourth message may be one or more of the following: a HANDOVER REQUEST message of Xn; or a HANDOVER REQUIRED message or a HANDOVER REQUEST message of NG; or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE CO-ORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the fourth message may include one or more of the following fields and/or related information:
transmitting node identification: identification of the node that transmits the fourth message.
receiving node identification: identification of the node that receives the fourth message.
applicable scope: a scope corresponding to a configuration about measurement relaxation, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
predicted handover time: which indicates information of an estimated handover time. This time may be set based on channel quality and movement information of the UE, such as location information, movement speed, movement direction, etc. This time is set for nodes to ensure handover performance. It may be a handover time estimated by the source node, or a handover time estimated by the target node. This time may be by means of the one or more of the following: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time.
acceptable handover time: which indicates an acceptable handover time of a node. This time may be set based on channel quality and movement information of the UE, such as location information, movement speed, movement direction, etc. This time is set for nodes to ensure handover performance. It may be an acceptable handover time of the source node, or an acceptable handover time of the target node. This time may be by means of the one or more of the following: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time.

In some implementations, the fourth node may transmit a fifth message containing handover time information of a target side (e.g., target node) to the third node, for the third node to perform handover. This handover time may be set based on the time required for a node (e.g., the target node) to wake up from an energy-saving state, so as to avoid handover failure due to the node's failure to perform handover operation in time due to the node is in an energy-saving state.

In some implementations, the fifth message may be one or more of the following: a HANDOVER REQUEST ACKNOWLEDGE message of Xn; or a HANDOVER COMMAND message or a HANDOVER REQUEST ACKNOWLEDGE message of NG; an RRCReconfiguration message or an RRCReestablishment message or an RRCSetup message or an RRCRelease message of Radio Resource Control (RRC); or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or or X2 and/or F1 and/or E1 and/or NG message.

In some implementations, the fifth message may include one or more of the following fields and/or related information:
transmitting node identification: identification of the node that transmits the fifth message.
receiving node identification: identification of the node that receives the fifth message.
applicable scope: a scope corresponding to a configuration about measurement relaxation, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
handover time: used to indicate a handover time of the UE, which may also be a time when handover command is issued to the UE, or a time when handover configuration (for example, RRC reconfiguration message) is issued to the UE. This time may be by means of the one or more of the following: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time.

### EXAMPLE 4

An example of the present disclosure proposes a method for supporting network energy-saving, which may include: a sixth node transmits a sixth message containing handover configuration effective information to a fifth node, in order for the fifth node to be able to activate and apply handover configuration at an appropriate time, to avoid handover failure. For example, during a handover process, a target node is in an energy-saving state and cannot perform a handover operation in time, therefore a configuration effective/validity time is taken when setting the handover configuration. After receiving the configuration, the UE performs a related handover operation when the effective/validity time is satisfied, but not perform the related handover operation immediately after receiving the configuration. In some implementations, for example, during a handover process, the source node is to enter an energy-saving state, and the UE needs to be handed over to a neighboring cell. After receiving the handover configuration effective/validity information, the UE performs a related handover operation when a configuration effective/validity condition and/or time is satisfied, so as to ensure the performance of the UE. In some implementations, for example, during a handover process, the source node is to enter an energy-saving state, and the UE needs to be handed over to a neighboring cell, and the neighboring cell needs to be switched from an energy-saving state to a non-energy-saving state. After receiving the handover configuration effective/validity information, the UE performs a related handover operation when a configuration effective/validity condition and/or time is satisfied, so as to ensure the performance of the UE and avoid handover failure.

In some implementations, the sixth message may be one or more of the following: a HANDOVER REQUEST ACKNOWLEDGE message of Xn; or a HANDOVER COMMAND message or a HANDOVER REQUEST ACKNOWLEDGE message of NG; an RRCReconfiguration message or an RRCReestablishment message or an RRCSetup message or an RRCRelease message of Radio Resource Control (RRC); or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the sixth message may include one or more of the following fields and/or related information:
transmitting node identification: identification of the node that transmits the sixth message.
receiving node identification: identification of the node that receives the sixth message.
applicable scope: a scope corresponding to a, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
effective/validity time of an execution condition: used to indicate an effective/validity time of an execution condition when a conditional handover is performed. This time may be by means of the one or more of the following: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time.
effective/validity time of a configuration: used to indicate an effective/validity time of the handover configuration, for example, it may be an effective/validity time of an RRC configuration or RRC reconfiguration. This time may be by means of the one or more of the following: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time.
execution condition: used to indicate an execution condition for conditional handover configured to the UE. The condition may be one or more of the following: it is received that the node will enter an energy-saving mode, etc. In some implementations, for example, after the UE receives the execution condition, and then after the UE receives information that a node (for example, the source node) is to enter an energy-saving mode, the UE performs handover and/or further detects whether another configured execution condition is satisfied, and if another configured execution condition is satisfied, the UE performs handover.

### EXAMPLE 5

An example of the present disclosure proposes a method for supporting network energy-saving, which may include: when a node finds that a UE is in a static state and/or a low-speed moving state, the node saves the location and/or movement information of the UE, such as beam, location coordinates, moving speed, cell, etc. When the UE enters an RRC inactive state and/or an RRC idle state, and the node needs to page the UE (and/or in the case of receiving messages from other nodes), the node may use the location and/or movement information of the UE to page the UE on related beams and/or other transmitting ends, so that the UE can be accurately paged, so as to reduce energy consumption of paging on every beam.

In some implementations, the node may save the location and/or movement information of the UE when releasing the UE context.

### EXAMPLE 6

An example of the present disclosure proposes a method for supporting network energy-saving, which may include: a seventh node transmits a seventh message containing a reference signal transmission suggestion to an eighth node, in order for the eighth node and/or other nodes to transmit reference signals according to the suggestion, so as to avoid the eighth node from transmitting unnecessary reference signals and achieve a purpose of energy-saving. In some implementations, after the seventh node obtains information about measurement relaxation of a UE, and obtains that the UE's reference signal measurement for a neighboring cell is changed (such as the measurement interval is increased, or the reference signals measured are reduced, etc.), the seventh node may suggest the neighboring cell to update a reference signal transmission configuration, such as increasing the transmission interval, or reducing the transmitted reference signals, etc. The seventh node may transmit the reference signal transmission suggestion to a related neighboring node, for example, the eighth node. The eighth node knows the acceptable reference signal transmission configuration of the seventh node, and updates its reference signal transmission configuration according to the suggestion and/or its own situation and/or suggestions received from other nodes, so as to reduce unnecessary reference signal transmission and the corresponding reference signal transmission energy consumption. In some other implementations, the UE may suggest a transmission configuration of reference signals of the base station based on its measurement situation and/or its own situation (for example, it may be a movement situation, including a movement speed and direction, etc.), and the base station may update its reference signal transmission configuration based on the suggestions received from one or more UEs to reduce un-necessary reference signal transmission and reduce the corresponding reference signal transmission energy consumption. Suggested may also be Preferred. A reference signal transmission suggestion may also be a preferred reference signal transmission strategy. Herein, the other nodes may be any network node except the eighth node.

In some implementations, the seventh message may be one or more of the following: it may be a MEASUREMENT REPORT message of RRC; or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; a HANDOVER REQUEST ACKNOWLEDGE message or a RETRIEVE UE CONTEXT REQUEST message or a HANDOVER SUCCESS message of X2 or Xn; or a SENB ADDITION REQUEST ACKNOWLEDGE message or a SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the seventh message may include one or more of the following fields and/or related information:
transmitting node identification: identification of the node that transmits the seventh message.
receiving node identification: identification of the node that receives the seventh message.
applicable scope: a scope corresponding to a suggested reference signal transmission configuration, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
suggested reference signal transmission configuration: this configuration may be a configuration for the present, or a configuration for a certain time in the future, or a predicted configuration. It may include one or more of the following:
   signal type, which may include one or more of the following: SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal, etc. Herein, the Radio Link Monitoring Reference Signal may include one or more of the following:
Synchronization Signal Block (SSB), Channel-State Information (CSI) reference signal, and a combination/mix of SSB and CSI-RS; and the Beam Failure Detection reference signal may include CSI-RS.
   reference signal transmission period
   reference signal transmission interval
   reference signal transmission mode: for example, it may include one or more of the following: periodic, aperiodic, semi-periodic and single transmission, etc.
   discontinuous reception (DRX)/discontinuous transmission (DTX) mode information of reference signal transmission: it may include one or more of the following: period, frequency information, time information, start time, end time, receiving time, non-receiving time, transmitting time, non-transmitting time, receiving frequency and/or resources, non-receiving frequency and/or resources, transmitting frequency and/or resources, and non-transmitting frequency and/or resources, etc.
   transmission frequency information of the reference signal, which may include one or more of the following: BWP, central frequency, frequency hopping information, etc.
   start of the suggested configuration
   start time of the suggested configuration
   end of the suggested configuration
   end time of the suggested configuration
   applicable/validity time corresponding to a predicted reference signal transmission configuration: used to indicate an applicable/validity time point and/or applicable/validity time period of a predicted reference signal transmission configuration. This time may be a relative time or an absolute time. If it is a time interval, it may be indicated by 2*n bits, for example, the first n bits indicate a start time and the last n bits indicate an end time. Or it may be indicated by separate fields, including one or more of the following:
      start time: used to indicate a start time. The starting time may be a relative time or an absolute time.
      end time: used to indicate an end time. The end time may be a relative time or an absolute time.

In some implementations, the eighth node may transmit an eighth message containing a reference signal transmission configuration of the eighth node and/or other nodes to the seventh node according to its own situation (for example, autonomously) and/or according to the received seventh message containing the reference signal transmission suggestion, in order for the seventh node to obtain the reference signal transmission configuration of the eighth node and/or other nodes for measurement configuration update, etc. For example, when receiving a reference signal configuration update of a neighboring cell, the seventh node may update its measurement configuration for the UE and/or update its configuration about measurement relaxation for the UE. Suggested may also be Preferred.

In some implementations, the eighth message may be one or more of the following: an RRCReconfiguration message or an RRCReestablishment message or an RRCSetup message or an RRCRelease message of Radio Resource Control (RRC); or an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; OR a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; or an other and/or newly defined RRC and/or Xn and/or X2 and/or F1 and/or E1 and/or NG message.

In some implementations, the eighth message may include one or more of the following fields and/or related information:
transmitting node identification: identification of the node that transmits the eighth message.
receiving node identification: identification of the node that receives the eighth message.
applicable scope: a scope corresponding to a, which may be identifications and/or identification lists of one or more of the following: UE, cell, slice (for example, it may be identified by Single Network Slice Selection Assistance Information (S-NSSAI)), Bandwidth Part (BWP), subframe, slot, symbol, carrier, etc.
acceptance and/or rejection of a reference signal transmission suggestion: it may also be acceptance and/or rejection of a preferred reference signal transmission strategy. It may include one or more of the following: accept, partially accept, reject, and partially reject.
reference signal transmission configuration: this configuration may be a configuration for the present, or a configuration for a certain time in the future, or a predicted configuration. This configuration may also be an acceptable configuration, and it may also be an unacceptable and/or rejected configuration. It may include one or more of the following:
   signal type, which may include one or more of the following: SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal, etc. Herein, the Radio Link Monitoring Reference Signal may include one or more of the following: Synchronization Signal Block (SSB), Channel-State Information (CSI) reference signal, and a combination/mix of SSB and CSI-RS; and the Beam Failure Detection reference signal may include CSI-RS.
   reference signal transmission period
   reference signal transmission interval
   reference signal transmission mode: for example, it may include one or more of the following: periodic, aperiodic, semi-periodic and single transmission, etc.
   DRX/DTX mode information of reference signal transmission: it may include one or more of the following: period, frequency information, time information, start time, end time, receiving time, non-receiving time, transmitting time, non-transmitting time, receiving frequency and/or resources, non-receiving frequency and/or resources, transmitting frequency and/or resources, and non-transmitting frequency and/or resources, etc.
   transmission frequency information of the reference signal, which may include one or more of the following: BWP, central frequency, frequency hopping information, etc.
   start of the configuration
   start time of the configuration
   end of the configuration
   end time of the configuration
   applicable/validity time corresponding to a predicted reference signal transmission configuration: used to indicate an applicable/validity time point and/or applicable/validity time period of a predicted reference signal transmission configuration. This time may be a relative time or an absolute time. If it is a time interval, it may be indicated by 2*n bits, for example, the first n bits indicate a start time and the last n bits indicate an end time. Or it may be indicated by separate fields, including one or more of the following:
      start time: used to indicate a start time. The starting time may be a relative time or an absolute time.
      end time: used to indicate an end time. The end time may be a relative time or an absolute time.

In an implementation, it may also be that the seventh node transmits a seventh message containing a reference signal transmission suggestion to the eighth node, which is a reference signal transmission suggestion of the seventh node preferred by the seventh node. After the eighth node obtains the suggestion, it accepts and/or rejects the seventh node's transmission suggestion for the seventh node according to the information obtained by the eighth node, and the eighth node transmits an eighth message containing a reference signal transmission configuration to the seventh node, so as to prevent the decision made by the seventh node according to its own information from causing other nodes'performance reduction. In an implementation, for example, it may be that a node determines its own preferred reference signal transmission strategy and transmit a seventh message containing the preferred reference signal transmission strategy to a neighboring node. After the neighboring node obtains the preferred transmission strategy, it accepts and/or rejects the preferred transmission strategy according to the information of the neighboring node, and the neighboring node transmits a reference signal transmission configuration and/or an acceptance and/or rejection result to the node through the eighth message, so as to avoid the decision made by the node based on its own information from causing other neighboring nodes'performance reduction. For example, it may be that the other nodes'energy consumption increases and can not achieve a global energy-saving. In another implementation, for example, it may be that a gNB DU determines its own preferred reference signal transmission strategy and transmit a seventh message containing the preferred reference signal transmission strategy to a gNB CU. After obtaining the preferred transmission strategy, the gNB CU accepts and/or rejects the preferred transmission strategy according to its own information, the obtained information of other gNB DUs and the obtained information of neighboring nodes. The gNB CU transmits a reference signal transmission configuration and/or an acceptance and/or rejection result to the gNB DU through the eighth message, so as to avoid the decision made by the gNB DU based on its own information from causing other nodes'performance reduction. For example, it may be that the other nodes'energy consumption increases and can not achieve a global energy-saving.

The network self-optimization decision mentioned in the present disclosure may include network energy-saving, load balancing, coverage optimization, mobility optimization and/or management, network configuration update, etc.

The time mentioned in the present disclosure may be expressed by one or more of the following methods: time stamp, time point, time interval, timer, time period, time length, etc. Herein the time length may be a time length from a certain time point, which may be the current time. It may also be indicated by separate fields which, for example, may include one or more of the following: start time, end time, etc. This time may be a relative time or an absolute time. This time may be a relative time or an absolute time.

In addition, in the present disclosure, state and mode can refer to each other.

In addition, in the present disclosure, suggested may also be Preferred.

In addition, in the present disclosure, the signals and/or reference signals may include any uplink and/or downlink signal, for example, SSB, CSI-RS, Demodulation Reference Signal (DMRS), Sounding Reference Signal (SRS), Phase-tracking reference signals (PTRS), Radio Link Monitoring (RLM) Reference Signal (RS), and Beam Failure Detection reference signal, etc. Herein, the Radio Link Monitoring Reference Signal may include one or more of the following: Synchronization Signal Block (SSB), Channel-State Information (CSI) reference signal, and a combination/mix of SSB and CSI-RS; and the Beam Failure Detection reference signal may include CSI-RS.

In addition, in the present disclosure, measurement relaxation may also be a Relaxed Measurement.

In addition, in the present disclosure, an “execution condition” may also be an “execution event”, or a “conditional event”, or an “event”, which are not limited in the present disclosure.

In addition, in the present disclosure, ordinal numbers such as “first” and “second” are only used to distinguish specific terms in specific examples, and these terms can be used interchangeably or refer to each other. For example, any one of “first node” to “eighth node” may refer to any other one of “first node” to “eighth node” throughout different examples.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

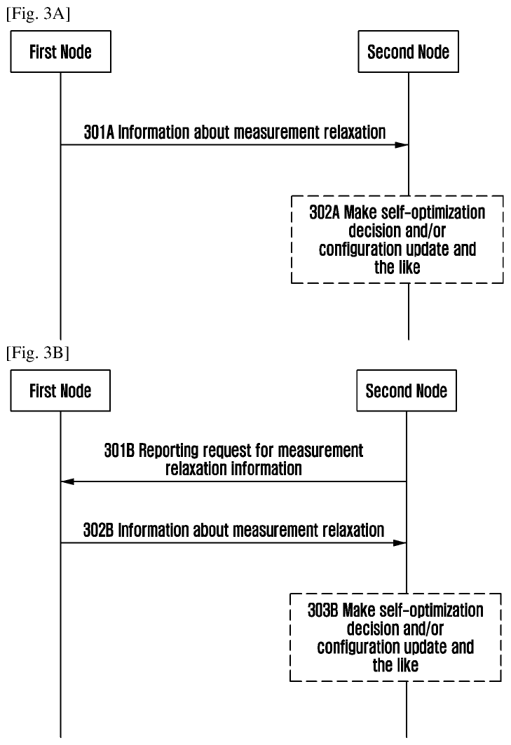

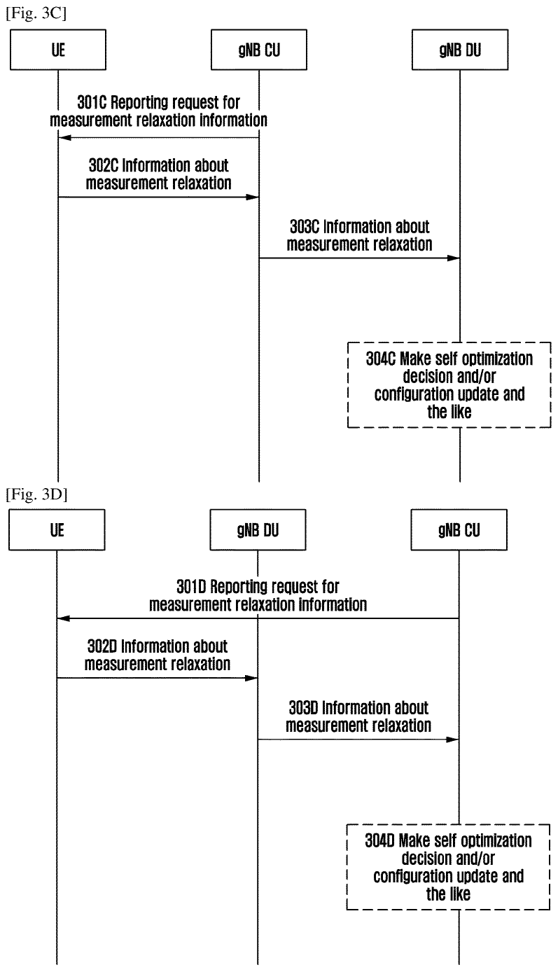

FIG. 3A illustrates a schematic diagram of an aspect of a method for supporting network energy-saving according to embodiments of the present disclosure. Specifically, FIG. 3A shows a process of exchanging information about measurement relaxation between two nodes, so that the second node may make network energy-saving configuration update and/or self-optimization decision and the like according to the received information about measurement relaxation. In some implementations, for example, the first node may be a UE, and the second node may be a gNB or a gNB-CU or a gNB-DU or a gNB CU-CP or a gNB CU-UP or an en-gNB or an eNB or a ng-eNB. In some other implementations, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In still other implementations, for example, the first node may be an AMF or an SMF or an MME, and the second node may be a gNB or a gNB-CU or a gNB CU-CP or an en-gNB or an eNB or a ng-eNB. In yet other implementations, for example, the first node may be a gNB or a gNB-CU or a gNB CU-CP or an en-gNB or an eNB or a ng-eNB, and the second node may be an AMF or an SMF or an MME.

Step 301A: the first node transmits information about measurement relaxation to the second node. The information about measurement relaxation may be the afore-mentioned second message.

Step 302A: the second node may make network energy-saving configuration update and/or self-optimization decision and the like according to the received information about measurement relaxation. In some implementations, for example, when receiving that the UE only measures a part of the reference signals, the second node may not transmit reference signals that the UE does not measure, so as to achieve a purpose of energy-saving. In some other implementations, for example, when receiving that the UE increases the measurement interval of the reference signals, the second node may increase the transmission interval of the reference signals to achieve a purpose of energy-saving, where the interval may be either a frequency domain interval or a time domain interval.

FIG. 3B illustrates a schematic diagram of an aspect of a method for supporting network energy-saving according to embodiments of the present disclosure. Specifically, FIG. 3B shows a process of exchanging information about measurement relaxation between two nodes, so that the second node can make network energy-saving configuration update and/or self-optimization decision and the like according to the received network energy-saving configuration. In some implementations, for example, the first node may be a UE, and the second node may be a gNB or a gNB-CU or a gNB-DU or a gNB CU-CP or a gNB CU-UP or an en-gNB or an eNB or a ng-eNB. In some other implementations, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In still other implementations, for example, the first node may be an AMF or an SMF or an MME, and the second node may be a gNB or a gNB-CU or a gNB CU-CP or an en-gNB or an eNB or a ng-eNB. In yet other implementations, for example, the first node may be a gNB or a gNB-CU or a gNB CU-CP or an en-gNB or an eNB or a ng-eNB, and the second node may be an AMF or an SMF or an MME.

Step 301B: the second node transmits a reporting request for information about measurement relaxation to the first node. The reporting request for information about measurement relaxation may be the aforementioned first message.

Step 302B: the first node transmits information about measurement relaxation to the second node. The information about measurement relaxation may be the afore-mentioned second message.

Step 303B: the second node may make network energy-saving configuration update and/or self-optimization decision and the like according to the received information about measurement relaxation. In some implementations, for example, when receiving that the UE only measures a part of the reference signals, the second node may not transmit reference signals that the UE does not measure, so as to achieve a purpose of energy-saving. In some other implementations, for example, when receiving that the UE increases the measurement interval of the reference signals, the second node may increase the transmission interval of the reference signals to achieve a purpose of energy-saving, where the interval may be either a frequency domain interval or a time domain interval.

FIG. 3C illustrates a schematic diagram of an aspect of a method for supporting network energy-saving according to embodiments of the present disclosure.

Specifically, FIG. 3C shows a process in which a gNB CU, a gNB DU and a UE exchange information about measurement relaxation under a split architecture, and the gNB DU can obtain information about measurement relaxation of the UE, so that the gNB DU can make network energy-saving configuration update and/or self-optimization decision and the like according to the received network energy-saving configuration.

Step 301C: the gNB CU transmits a reporting request for information about measurement relaxation to the UE. The reporting request for information about measurement relaxation may be the aforementioned first message.

Step 302C: the UE transmits information about measurement relaxation to the gNB CU. The information about measurement relaxation may be the aforementioned second message.

Step 303C: the gNB CU transmits information about measurement relaxation to the gNB DU. The information about measurement relaxation may be the aforementioned second message.

Step 304C: the gNB DU can make network energy-saving configuration update and/or self-optimization decision and the like according to the received information about measurement relaxation. In some implementations, for example, when receiving that the UE only measures a part of the reference signals, the gNB DU may not transmit reference signals that the UE does not measure, so as to achieve a purpose of energy-saving. In some other implementations, for example, when receiving that the UE increases the measurement interval of the reference signals, the gNB DU may increase the transmission interval of the reference signals to achieve a purpose of energy-saving, where the interval may be either a frequency domain interval or a time domain interval.

FIG. 3D illustrates a schematic diagram of an aspect of a method for supporting network energy-saving according to embodiments of the present disclosure.

Specifically, FIG. 3D shows a process in which a gNB CU, a gNB DU and a UE exchange information about measurement relaxation under a split architecture, and the gNB CU can obtain information about measurement relaxation of the UE, so that the gNB CU can make network energy-saving configuration update and/or self-optimization decision and the like according to the received network energy-saving configuration.

Step 301D: the gNB CU transmits a reporting request for information about measurement relaxation to the UE. The reporting request for information about measurement relaxation may be the aforementioned first message.

Step 302D: the UE transmits information about measurement relaxation to the gNB DU. The information about measurement relaxation may be the aforementioned second message.

Step 303D: the gNB DU transmits information about measurement relaxation to the gNB CU. The information about measurement relaxation may be the aforementioned second message.

Step 304D: the gNB CU can make network energy-saving configuration update and/or self-optimization decision and the like according to the received information about measurement relaxation. In some implementations, for example, when receiving that the UE only measures a part of the reference signals, the gNB CU may set the reference signal transmission configuration, for example, to configure the gNB DU and/or the gNB CU not to transmit reference signals that the UE does not measure, so as to achieve a purpose of energy-saving. In some other implementations, for example, when receiving that the UE increases the measurement interval of the reference signals, the gNB CU may set the reference signal transmission configuration, for example, to configure the gNB DU and/or gNB CU to increase the transmission interval of the reference signals, so as to achieve a purpose of energy-saving, where the interval may be either a frequency domain interval or a time domain interval.

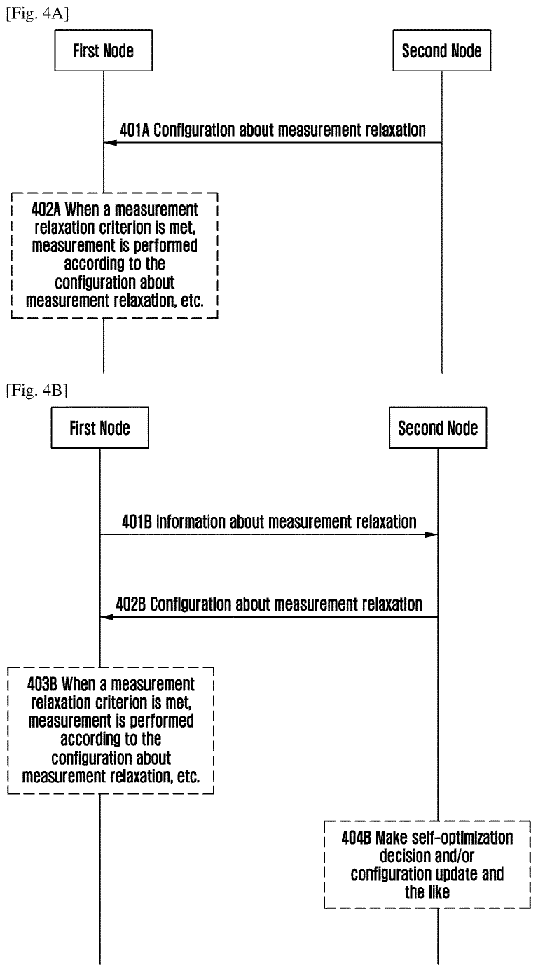

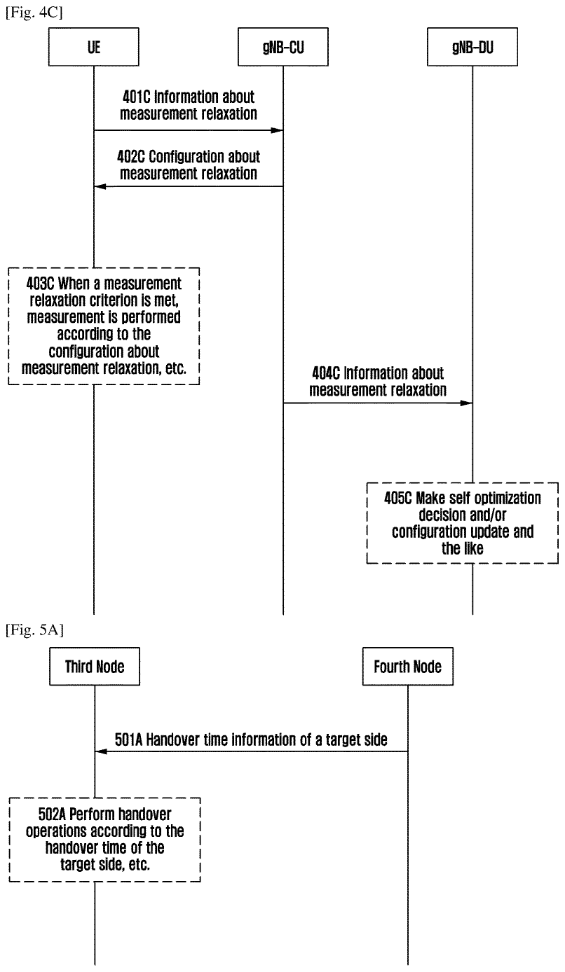

FIG. 4A illustrates a schematic diagram of an aspect of a method for supporting network energy-saving according to embodiments of the present disclosure. Specifically, FIG. 4A shows a process of exchanging configuration about measurement relaxation between two nodes, so that the first node may perform measurement relaxation measurement according to the configuration about measurement relaxation obtained from the second node, so as to unify the measurement relaxation measurement, so that the nodes can make network energy-saving configuration update and/or self-optimization decision and the like according to the unified measurement relaxation measurement, so as to achieve a purpose of energy-saving. In some implementations, for example, the first node may be a UE, and the second node may be a gNB or a gNB-CU or a gNB-DU or a gNB CU-CP or a gNB CU-UP or an en-gNB or an eNB or a ng-eNB. In some other implementations, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In still other implementations, for example, the first node may be an AMF or an SMF or an MME, and the second node may be a gNB or a gNB-CU or a gNB CU-CP or an en-gNB or an eNB or a ng-eNB. In yet other implementations, for example, the first node may be a gNB or a gNB-CU or a gNB CU-CP or an en-gNB or an eNB or a ng-eNB, and the second node may be an AMF or an SMF or an MME.

Step 401A: the second node transmits a configuration about measurement relaxation to the first node. The configuration about measurement relaxation may be the afore-mentioned third message.

Step 402A: the first node may perform measurement according to the received configuration about measurement relaxation. In some implementations, for example, when the first node meets a measurement relaxation criterion, the first node performs measurement according to the configuration about measurement relaxation.

FIG. 4B illustrates a schematic diagram of an aspect of a method for supporting network energy-saving according to embodiments of the present disclosure. Specifically, FIG. 4B shows a process of exchanging configuration about measurement relaxation between two nodes, so that the first node may perform measurement relaxation measurement according to the configuration about measurement relaxation obtained from the second node, so as to unify the measurement relaxation measurement, so that the nodes can make network energy-saving configuration update and/or self-optimization decision and the like according to the unified measurement relaxation measurement, so as to achieve a purpose of energy-saving. In some implementations, for example, the first node may be a UE, and the second node may be a gNB or a gNB-CU or a gNB-DU or a gNB CU-CP or a gNB CU-UP or an en-gNB or an eNB or a ng-eNB. In some other implementations, for example, the first node may be a gNB or a gNB-CU or a gNB-DU or a gNB CU-CP or a gNB CU-UP or an en-gNB or an eNB or a ng-eNB, and the second node may be a gNB or a gNB-CU or a gNB-DU or a gNB CU-CP or a gNB CU-UP or an en-gNB or an eNB or a ng-eNB. In still other implementations, for example, the first node may be an AMF or an SMF or an MME, and the second node may be a gNB or a gNB-CU or a gNB CU-CP or an en-gNB or an eNB or a ng-eNB. In yet other implementations, for example, the first node may be a gNB or a gNB-CU or a gNB CU-CP or an en-gNB or an eNB or a ng-eNB, and the second node may be an AMF or an SMF or an MME.

Step 401B: the first node transmits information about measurement relaxation to the second node. The information about measurement relaxation may be the afore-mentioned second message.

Step 402B: the second node transmits a configuration about measurement relaxation to the first node. The configuration about measurement relaxation may be the afore-mentioned third message. In some implementations, after receiving the information about measurement relaxation from one or more first nodes based on step 401B, the second node sets a unified configuration about measurement relaxation, and transmits the configuration about measurement relaxation to some and/or all first nodes.

Step 403B: the first node may perform measurement according to the received configuration about measurement relaxation. In some implementations, for example, when the first node meets a measurement relaxation criterion, the first node performs measurement according to the configuration about measurement relaxation.

Step 404B: the second node may make network energy-saving configuration update and/or self-optimization decision and the like according to the unified measurement relaxation measurement, so as to achieve a purpose of energy-saving. In some implementations, for example, when receiving that the UE only measures a part of the reference signals, the second node may not transmit reference signals that the UE does not measure, so as to achieve a purpose of energy-saving. In some other implementations, for example, when receiving that the UE increases the measurement interval of the reference signals, the second node may increase the transmission interval of the reference signals to achieve a purpose of energy-saving, where the interval may be either a frequency domain interval or a time domain interval.

FIG. 4C illustrates a schematic diagram of an aspect of a method for supporting network energy-saving according to embodiments of the present disclosure. Specifically, FIG. 4C shows a process of exchanging information about measurement relaxation and configuration about measurement relaxation among a gNB CU, a gNB DU and a UE under a split architecture, so that the UE can perform a unified measurement relaxation measurement, so that the gNB DU can perform network energy-saving configuration update and/or self-optimization decision and the like according to the unified measurement relaxation measurement, so as to achieve a purpose of energy-saving.

Step 401C: the UE transmits information about measurement relaxation to the gNB CU. The information about measurement relaxation may be the aforementioned second message.

Step 402C: the gNB CU transmits the configuration about measurement relaxation to the UE. The configuration about measurement relaxation may be the aforementioned third message. In some implementations, after receiving information about measurement relaxation from one or more UEs based on step 401C, the second node sets a unified configuration about measurement relaxation, and transmits the configuration about measurement relaxation to some and/or all UEs.

Step 403C: the UE may perform measurement according to the received configuration about measurement relaxation. In some implementations, for example, when the UE meets a measurement relaxation criterion, the UE performs measurement according to the configuration about measurement relaxation.

Step 404C: the gNB CU transmits information about measurement relaxation to the gNB DU. The information about measurement relaxation may be the aforementioned second message. In some implementations, the information about measurement relaxation may be unified information about measurement relaxation.

Step 405C: the gNB DU can make network energy-saving configuration update and/or self-optimization decision and the like according to unified measurement relaxation measurement, so as to achieve a purpose of energy-saving. In some implementations, for example, when receiving that the UE only measures a part of the reference signals, the gNB DU may not transmit reference signals that the UE does not measure, so as to achieve a purpose of energy-saving. In some other implementations, for example, when receiving that the UE increases the measurement interval of the reference signals, the gNB DU can increase the transmission interval of the reference signals to achieve a purpose of energy-saving, where the interval may be either a frequency domain interval or a time domain interval.

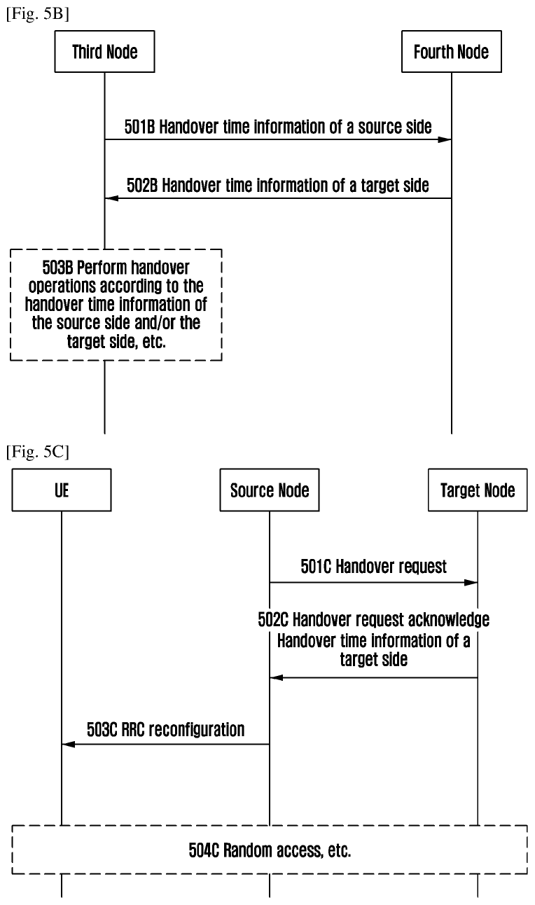

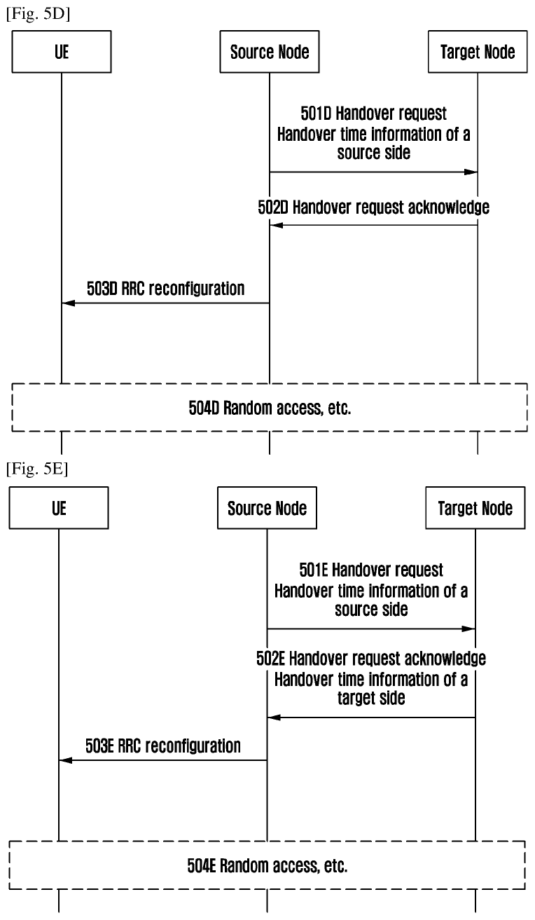

FIG. 5A illustrates a schematic diagram of an aspect of a method for supporting network energy-saving according to embodiments of the present disclosure. Specifically, FIG. 5A shows a process of exchanging handover time information of a target side between two nodes, so that the third node can obtain the handover time of the target side and provide reference information for subsequent handover processes. In some implementations, the handover time information is set based on the time when a target node changes from an energy-saving state to a non-energy-saving state, so as to avoid handover failure and/or handover performance reduction caused by the target node in an energy-saving state. Herein, the target node may be the fourth node, or any other target node from which the fourth node can obtain the handover time information thereof. In some implementations, for example, the third node may be a UE, and the fourth node may be a gNB or a gNB-CU or a gNB-DU or a gNB CU-CP or a gNB CU-UP or an en-gNB or an eNB or a ng-eNB. In some other implementations, for example, the third node may be a gNB or a gNB-CU or a gNB-DU or a gNB CU-CP or a gNB CU-UP or an en-gNB or an eNB or a ng-eNB, and the fourth node may be a gNB or a gNB-CU or a gNB-DU or a gNB CU-CP or a gNB CU-UP or an en-gNB or an eNB or a ng-eNB. In still other embodiments, for example, the third node may be an AMF or an SMF or an MME, and the fourth node may be a gNB or a gNB-CU or a gNB CU-CP or an en-gNB or an eNB or a ng-eNB. In yet other implementations, for example, the third node may be a gNB or a gNB-CU or a gNB CU-CP or an en-gNB or an eNB or a ng-eNB, and the fourth node may be an AMF or an SMF or an MME.

Step 501A: the fourth node transmits handover time information of a target side to the third node. The handover time information of a target side may be the afore-mentioned fifth message.

Step 502A: the third node may perform subsequent handover operations according to the received handover time information of the target side.

FIG. 5B illustrates a schematic diagram of an aspect of a method for supporting network energy-saving according to embodiments of the present disclosure. Specifically, FIG. 5B shows a process of exchanging handover time information between two nodes, so that the nodes can obtain the handover time of the source side and/or the target side and provide reference information for subsequent handover processes. In some implementations, the handover time information of the target side is set based on the time when a target node changes from an energy-saving state to a non-energy-saving state, so as to avoid handover failure and/or handover performance reduction caused by the target node in an energy-saving state. In some other implementations, the handover time information is set based on the channel quality and the mobility information of the UE, such as location information, moving speed, moving direction, etc., so as to ensure the performance of the user in the handover process. Herein, the source side (or source node) may be the third node, or any other source node from which the third node can obtain the handover time information thereof. In addition, as mentioned above, the target node may be the fourth node or any other target node from which the fourth node can obtain the handover time information thereof. In some implementations, for example, the third node may be a gNB or a gNB-CU or a gNB-DU or a gNB CU-CP or a gNB CU-UP or an en-gNB or an eNB or a ng-eNB, and the fourth node may be a gNB or a gNB-CU or a gNB-DU or a gNB CU-CP or a gNB CU-UP or an en-gNB or an eNB or a ng-eNB. In some other implementations, for example, the third node may be an AMF or an SMF or an MME, and the fourth node may be a gNB or a gNB-CU or a gNB CU-CP or an en-gNB or an eNB or a ng-eNB. In yet other implementations, for example, the third node may be a gNB or a gNB-CU or a gNB CU-CP or an en-gNB or an eNB or a ng-eNB, and the fourth node may be an AMF or an SMF or an MME.

Step 501B: the third node transmits handover time information of a source side to the fourth node. The handover time information of a source side may be the afore-mentioned fourth message.

Step 502B: the fourth node transmits handover time information of a target side to the third node. The handover time information of a target side may be the afore-mentioned fifth message.

Step 503B: the third node (for example, as a source node) may perform subsequent handover operations according to the handover time information of the source side and/or the received handover time information of the target side.

FIG. 5C illustrates a schematic diagram of an aspect of a method for supporting network energy-saving according to embodiments of the present disclosure. Specifically, FIG. 5C shows a process in which a UE, a source node and a target node exchange handover time information during handover, so that the nodes can obtain the handover time of a target side and provide reference information for subsequent handover processes. In some implementations, the handover time information of a target side is set based on the time when a target node changes from an energy-saving state to a non-energy-saving state, so as to avoid handover failure and/or handover performance reduction caused by the target node in an energy-saving state. In some other implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 501C: the source node transmits a handover request message to the target node.

Step 502C: the target node transmits a handover request acknowledge message carrying the handover time information of the target side to the source node. The handover time information of the target side may be the aforementioned fifth message.

Step 503C: the source node may perform subsequent handover operations according to the received handover time information of the target side, for example, transmit an RRC reconfiguration message to the UE according to the handover time information of the target side.

Step 504C: the UE performs random access with the target node, etc.

FIG. 5D illustrates a schematic diagram of an aspect of a method for supporting network energy-saving according to embodiments of the present disclosure. Specifically, FIG. 5D shows a process in which a UE, a source node and a target node exchange handover time information in a handover process, so that the nodes can obtain the handover time of a source side and provide reference information for subsequent handover processes. In some implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 501D: the source node transmits a handover request message carrying the handover time information of a source node to the target node. The handover time information of the source side may be the aforementioned fourth message.

Step 502D: the target node transmits a handover request acknowledge message to the source node. In some implementations, if the target node can accept the handover time information of the source side transmitted by the source node, the target node transmits a handover request acknowledge message to the source node to confirm the handover request. In some other implementations, if the target node cannot accept the handover time information of the source node transmitted by the source node, the target node transmits a handover preparation failure message to the source node.

Step 503D: the source node may perform subsequent handover operations according to the handover time information of the source side, for example, transmit an RRC re-configuration message to the UE according to the handover time information of the source side.

Step 504D: the UE performs random access with the target node, etc.

FIG. 5E illustrates a schematic diagram of an aspect of a method for supporting network energy-saving according to embodiments of the present disclosure. Specifically, FIG. 5E shows a process in which a UE, a source node and a target node exchange handover time information in a handover process, so that the nodes can obtain the handover time of the source side and/or the target side and provide reference information for the subsequent handover process. In some implementations, the handover time information of the target side is set based on the time when a target node changes from an energy-saving state to a non-energy-saving state, so as to avoid handover failure and/or handover performance reduction caused by the target node in an energy-saving state. In some other implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 501E: the source node transmits a handover request message carrying the handover time information of a source node to the target node. The handover time information of the source side may be the aforementioned fourth message.

Step 502E: the target node transmits a handover request acknowledge message carrying the handover time information of the target side to the source node. The handover time information of the target side may be the aforementioned fifth message. In some implementations, if the target node can accept the handover time information of the source side transmitted by the source node and/or accept part of the handover time information of the source side, the target node transmits a handover request acknowledge message to the source node to confirm the handover request. If the handover information of the source side is partially accepted, the partial information may be the handover time of the target side. In some other implementations, if the target node cannot accept the handover time information of the source node transmitted by the source node, the target node transmits a handover preparation failure message to the source node.

Step 503E: the source node may perform subsequent handover operations according to the handover time information of the source side and/or the received handover time information of the target side, for example, transmit an RRC reconfiguration message to the UE according to the handover time information of the source side and/or the handover time information of the target side.

Step 504E: the UE performs random access with the target node, etc.

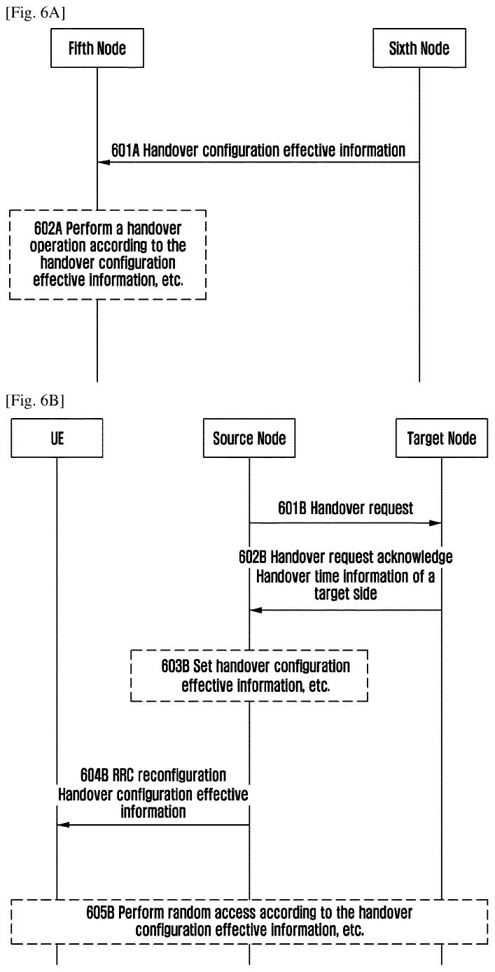

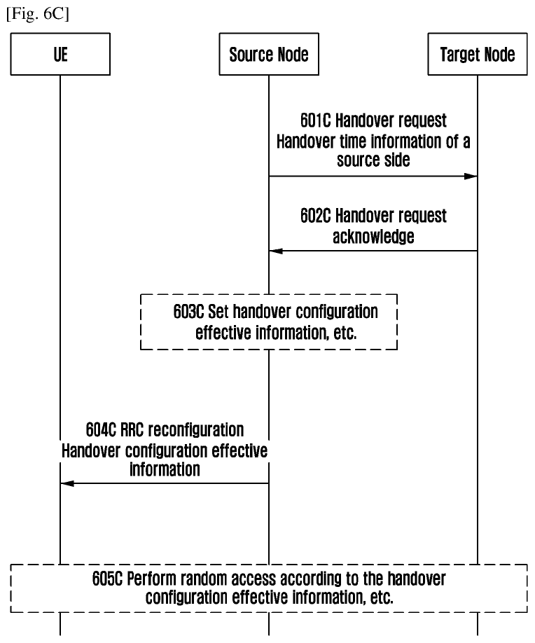

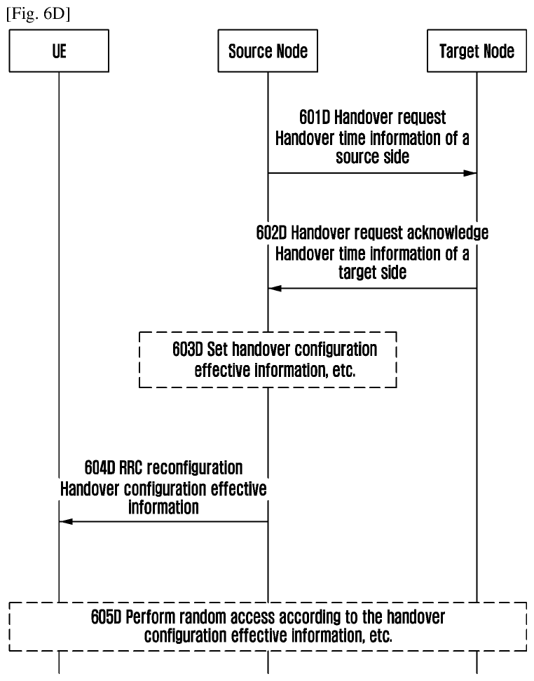

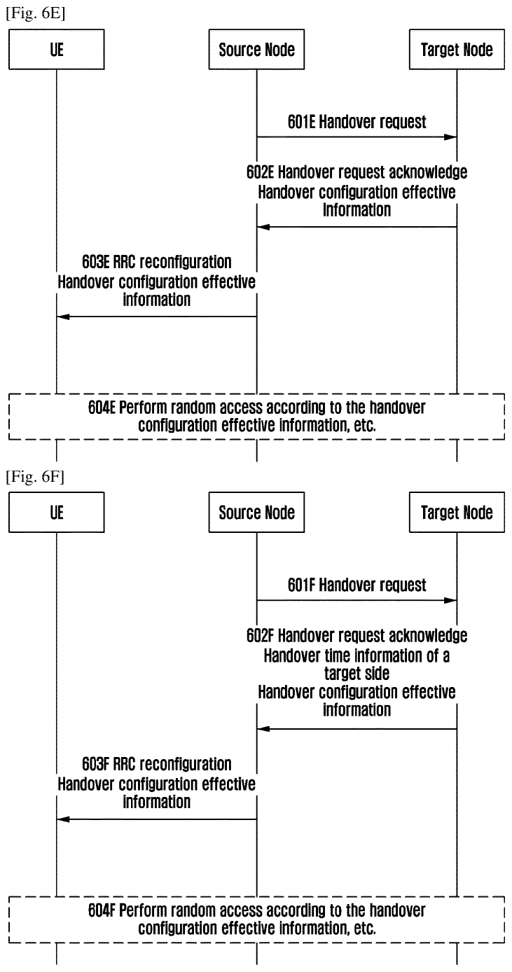

FIG. 6A illustrates a schematic diagram of an aspect of a method for supporting network energy-saving according to embodiments of the present disclosure. Specifically, FIG. 6A shows a process of exchanging handover configuration effective information between two nodes, so that the fifth node can obtain information such as an effective/validity time and/or an effective/validity event and the like of a received handover configuration and provide configuration information for a handover process. Only when the handover configuration is in an effective state, related handover actions can be triggered. In some implementations, the handover configuration start to take effect when the target node changes from an energy-saving state to a non-energy-saving state, so as to avoid handover failure and/or handover performance reduction caused by the target node in an energy-saving state. In some implementations, for example, during a handover process, the source node is to enter an energy-saving state, and the UE needs to be handed over to a neighboring cell. After receiving the handover configuration effective/validity information, the UE performs a related handover operation when a configuration effective/validity condition and/or time is satisfied, so as to ensure the performance of the UE. In some implementations, for example, during a handover process, the source node is to enter an energy-saving state, and the UE needs to be handed over to a neighboring cell, and the neighboring cell needs to be switched from an energy-saving state to a non-energy-saving state. After receiving the handover configuration effective/validity information, the UE performs a related handover operation when a configuration effective/validity condition and/or time is satisfied, so as to ensure the performance of the UE and avoid handover failure. In some implementations, for example, the fifth node may be a UE, and the sixth node may be a gNB or a gNB-CU or a gNB-DU or a gNB CU-CP or a gNB CU-UP or an en-gNB or an eNB or a ng-eNB. In some other implementations, for example, the fifth node may be a gNB or a gNB-CU or a gNB-DU or a gNB CU-CP or a gNB CU-UP or an en-gNB or an eNB or a ng-eNB, and the sixth node may be a gNB or a gNB-CU or a gNB-DU or a gNB CU-CP or a gNB CU-UP or an en-gNB or an eNB or a ng-eNB. In still other embodiments, for example, the fifth node may be an AMF or an SMF or an MME, and the sixth node may be a gNB or a gNB-CU or a gNB CU-CP or an en-gNB or an eNB or a ng-eNB. In yet other implementations, for example, the fifth node may be a gNB or a gNB-CU or a gNB CU-CP or an en-gNB or an eNB or a ng-eNB, and the sixth node may be an AMF or an SMF or an MME.

Step 601A: the sixth node transmits handover configuration effective information to the fifth node. The handover configuration effective information may be the afore-mentioned sixth message.

Step 602A: the fifth node may perform a handover operation and the like according to the received handover configuration effective information.

FIG. 6B illustrates a schematic diagram of an aspect of a method for supporting network energy-saving according to embodiments of the present disclosure. Specifically, FIG. 6B shows a process in which a UE, a source node and a target node exchange handover time information and/or handover configuration effective information in a handover process, so that the source node can obtain the handover time of the target side, and the source node may set the handover configuration effective information according to the handover time information of the target side, and only when the handover configuration is in an effective state, related handover operations can be performed. In some implementations, the handover time information of the target side is set based on the time when a target node changes from an energy-saving state to a non-energy-saving state, so as to avoid handover failure and/or handover performance reduction caused by the target node in an energy-saving state. In some other implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 601B: the source node transmits a handover request message to the target node.

Step 602B: the target node transmits a handover request acknowledge message carrying the handover time information of the target side to the source node. The handover time information of the target side may be the aforementioned fifth message.

Step 603B: the source node sets the handover configuration effective information according to the handover time of the target side.

Step 604B: the source node transmits an RRC reconfiguration message carrying the handover configuration effective information to the UE. The handover configuration effective information may be the aforementioned sixth message.

Step 605B: the UE performs random access with the target node according to the handover configuration effective information, etc.

FIG. 6C illustrates a schematic diagram of an aspect of a method for supporting network energy-saving according to embodiments of the present disclosure. Specifically, FIG. 6C shows a process in which a UE, a source node and a target node exchange handover time information and/or handover configuration effective information in a handover process, so that the source node can provide the handover time of the source side to the target node, and the target node can accept and/or reject the handover request according to the handover time information of the source side, and then the source node may set the handover configuration effective information and the like according to the handover time information of the source side, and only when the handover configuration is in an effective state, related handover operations can be performed. In some implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 601C: the source node transmits a handover request message carrying the handover time information of a source node to the target node. The handover time information of the source side may be the aforementioned fourth message.

Step 602C: the target node transmits a handover request acknowledge message to the source node. In some implementations, if the target node can accept the handover time information of the source side transmitted by the source node, the target node transmits a handover request acknowledge message to the source node to confirm the handover request. In some other implementations, if the target node cannot accept the handover time information of the source node transmitted by the source node, the target node transmits a handover preparation failure message to the source node.

Step 603C: the source node sets the handover configuration effective information according to the handover time of the source side.

Step 604C: the source node transmits an RRC reconfiguration message carrying the handover configuration effective information to the UE. The handover configuration effective information may be the aforementioned sixth message.

Step 605C: the UE performs random access with the target node according to the handover configuration effective information, etc.

FIG. 6D illustrates a schematic diagram of an aspect of a method for supporting network energy-saving according to embodiments of the present disclosure. Specifically, FIG. 6D shows a process in which a UE, a source node and a target node exchange handover time information and/or handover configuration effective information in a handover process, so that the source node can provide the handover time of the source side to the target node, and the target node can accept and/or reject the handover request according to the handover time information of the source side, and transmits handover time information of the target side to the source node, and then the source node may set the handover configuration effective information and the like according to the handover time information of the source node and/or target node, and only when the handover configuration is in an effective state, related handover operations can be performed. In some implementations, the handover time information of the target side is set based on the time when a target node changes from an energy-saving state to a non-energy-saving state, so as to avoid handover failure and/or handover performance reduction caused by the target node in an energy-saving state. In some other implementations, the handover time information is set based on the channel quality and the mobility information of the UE, such as location information, moving speed, moving direction, etc., so as to ensure the performance of the user in the handover process. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 601D: the source node transmits a handover request message carrying the handover time information of a source node to the target node. The handover time information of the source side may be the aforementioned fourth message.

Step 602D: the target node transmits a handover request acknowledge message carrying the handover time information of the target side to the source node. The handover time information of the target side may be the aforementioned fifth message. In some implementations, if the target node can accept the handover time information of the source side transmitted by the source node and/or accept part of the handover time information of the source side, the target node transmits a handover request acknowledge message to the source node to confirm the handover request. If the handover information of the source side is partially accepted, the partial information may be the handover time of the target side. In some other implementations, if the target node cannot accept the handover time information of the source node transmitted by the source node, the target node transmits a handover preparation failure message to the source node.

Step 603D: the source node sets the handover configuration effective information according to the handover time of the source side and/or the target side.

Step 604D: the source node transmits an RRC reconfiguration message carrying the handover configuration effective information to the UE. The handover configuration effective information may be the aforementioned sixth message.

Step 605D: the UE performs random access with the target node according to the handover configuration effective information, etc.

FIG. 6E illustrates a schematic diagram of an aspect of a method for supporting network energy-saving according to embodiments of the present disclosure. Specifically, FIG. 6E shows a process in which a UE, a source node and a target node exchange handover configuration effective information in a handover process, so that the UE can obtain the handover configuration effective information, and only when the handover configuration is in an effective state, related handover operations can be performed. In some implementations, the handover configuration effective information is set based on the time when a target node changes from an energy-saving state to a non-energy-saving state, so as to avoid handover failure and/or handover performance reduction caused by the target node in an energy-saving state. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 601E: the source node transmits a handover request message to the target node.

Step 602E: the target node transmits a handover request acknowledge message carrying handover configuration effective information to the source node. The handover configuration effective information may be the aforementioned sixth message.

Step 603E: the source node transmits an RRC reconfiguration message carrying the handover configuration effective information to the UE. The handover configuration effective information may be the aforementioned sixth message.

Step 604E: the source node transmits an RRC reconfiguration message carrying handover configuration effective information to the UE. The handover configuration effective information may be the aforementioned sixth message.

Step 605E: the UE performs random access with the target node according to the handover configuration effective information, etc.

FIG. 6F illustrates a schematic diagram of an aspect of a method for supporting network energy-saving according to embodiments of the present disclosure. Specifically, FIG. 6F shows a process in which a UE, a source node and a target node exchange handover time information of a target side and/or handover configuration effective information in a handover process. The source node can determine whether to cancel the handover according to the handover time information of the target side. For example, if the handover time of the target side is too long, which may lead to a radio link failure of the UE, the source node cancels the handover. If the source node can accept the handover time of the target side, the UE can obtain the handover configuration effective information, and only when the handover configuration is in an effective state, related handover operations can be performed. In some implementations, the handover time information of the target side is set based on the time when a target node changes from an energy-saving state to a non-energy-saving state, so as to avoid handover failure and/or handover performance reduction caused by the target node in an energy-saving state. In some other implementations, the handover configuration effective information is set based on the time when a target node changes from an energy-saving state to a non-energy-saving state, so as to avoid handover failure and/or handover performance reduction caused by the target node in an energy-saving state. In some implementations, for example, the source node may be a gNB or a gNB-CU or a gNB-DU or a gNB CU-CP or a gNB CU-UP or an en-gNB or an eNB or a ng-eNB, and the target node may be a gNB or a gNB-CU or a gNB-DU or a gNB CU-CP or a gNB CU-UP or an en-gNB or an eNB or a ng-eNB.

Step 601F: the source node transmits a handover request message to the target node.

Step 602F: the target node transmits a handover request acknowledge message carrying handover time information of the target side and/or handover configuration effective information to the source node. The handover time information of the target side may be the aforementioned fifth message. The handover configuration effective information may be the aforementioned sixth message. The source node can determine whether to cancel the handover according to the handover time information of the target side. For example, if the handover time of the target side is too long, which may lead to a radio link failure of the UE, the source node cancels the handover.

Step 603F: the source node transmits an RRC reconfiguration message carrying the handover configuration effective information to the UE. The handover configuration effective information may be the aforementioned sixth message.

Step 604F: the UE performs random access with the target node according to the handover configuration effective information, etc.

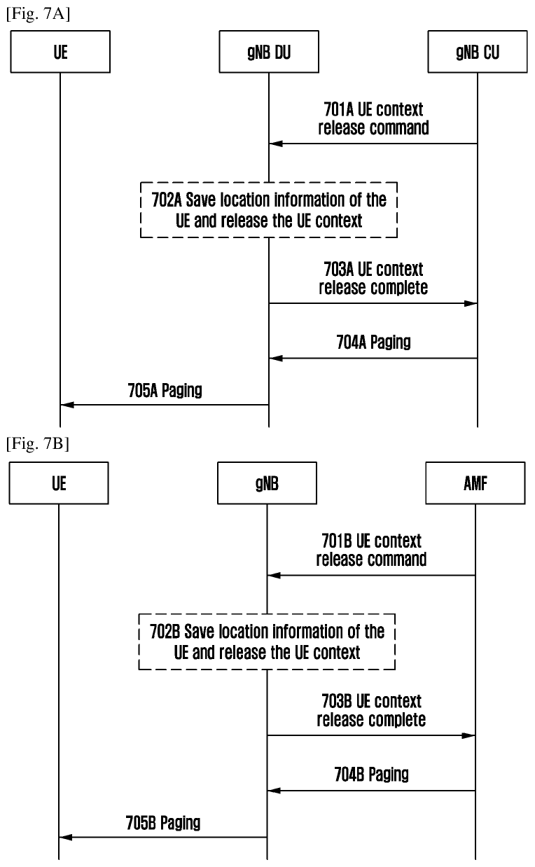

FIG. 7A illustrates a schematic diagram of an aspect of a method for supporting network energy-saving according to embodiments of the present disclosure. Specifically, FIG. 7A shows that when a gNB DU finds that a UE is in a static state and/or a low-speed moving state, the gNB DU saves the location and/or movement information of the UE. When the UE enters an RRC inactive state and/or an RRC idle state, and the node needs to page the UE (and/or in the case of receiving messages from other nodes), the node may use the location and/or movement information of the UE to page the UE on related beams and/or other transmitting ends, so that the UE can be accurately paged, so as to reduce energy consumption of paging on every beam.

Step 701A: the gNB CU transmits a UE context release command to the gNB DU.

Step 702A: when the gNB DU finds that the UE is in a static state and/or a low-speed moving state, the gNB DU saves the location and/or movement information of the UE, such as beam, location coordinates, moving speed, cell, etc., and releases the context information of the UE.

Step 703A: the gNB DU transmits a UE context release complete message to the gNB CU.

Step 704A: the gNB CU transmits a paging message to the gNB DU.

Step 705A: the gNB DU can use the stored location and/or movement information of the UE to page the UE on related beams and/or other transmitting ends, so that the UE can be accurately paged, so as to reduce energy consumption of paging on every beam.

FIG. 7B illustrates a schematic diagram of an aspect of a method for supporting network energy-saving according to embodiments of the present disclosure. Specifically, FIG. 7B shows that when a gNB finds that a UE is in a static state and/or a low-speed moving state, the gNB saves the location and/or movement information of the UE. After the UE enters an RRC inactive state and/or an RRC idle state, and when the nodes (and/or receives messages from other nodes) needs to page the UE, the node can use the location and/or movement information of the UE to page the UE on related beams and/or other transmitting ends, so that the UE can be accurately paged, so as to reduce energy consumption of paging on every beam.

Step 701B: the AMF transmits a UE context release command to the gNB.

Step 702B: when the gNB finds that the UE is in a static state and/or a low-speed moving state, the gNB saves the location and/or movement information of the UE, such as beam, location coordinates, moving speed, cell, etc., and will release the context information of the UE.

Step 703B: the gNB transmits a UE context release complete message to the AMF.

Step 704B: the AMF transmits a paging message to the gNB.

Step 705B: the gNB can use the stored location and/or movement information of the UE to page the UE on related beams and/or other transmitting ends, so that the UE can be accurately paged, so as to reduce energy consumption of paging on every beam.

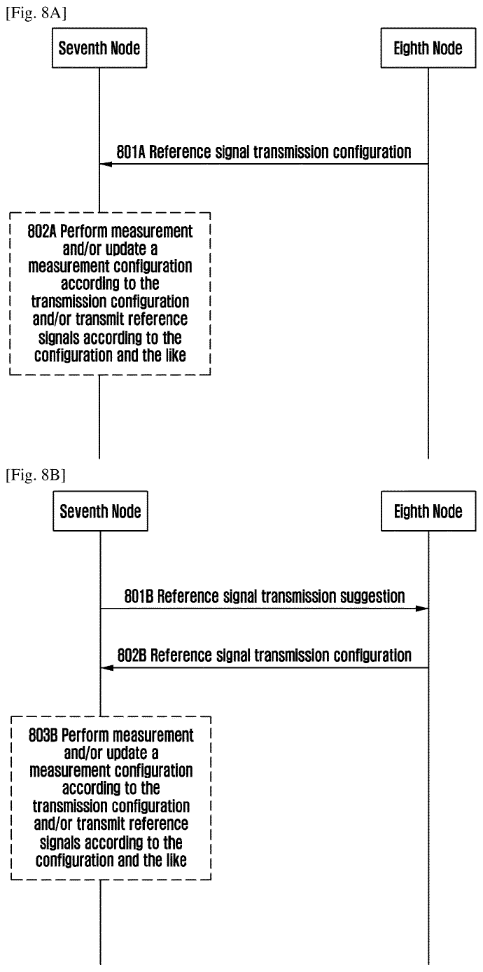

FIG. 8A illustrates a schematic diagram of an aspect of a method for supporting network energy-saving according to embodiments of the present disclosure. Specifically, FIG. 8A shows a process of exchanging reference signal transmission configuration between two nodes, so that the seventh node can perform measurement and/or update a measurement configuration according to the reference signal transmission configuration of the eighth node and/or the seventh node and/or other nodes obtained from the eighth node and/or transmit reference signals according to the configuration, so as to avoid unnecessary reference signal measurement and/or un-necessary reference signal transmission and achieve a purpose of energy-saving. In some implementations, for example, the seventh node may be a UE, and the eighth node may be a gNB or a gNB-CU or a gNB-DU or a gNB CU-CP or a gNB CU-UP or an en-gNB or an eNB or a ng-eNB. In some other implementations, for example, the seventh node may be a gNB or a gNB-CU or a gNB-DU or a gNB CU-CP or a gNB CU-UP or an en-gNB or an eNB or a ng-eNB, and the eighth node may be a gNB or a gNB-CU or a gNB-DU or a gNB CU-CP or a gNB CU-UP or an en-gNB or an eNB or a ng-eNB. In yet other implementations, for example, the seventh node may be an AMF or an SMF or an MME, and the eighth node may be a gNB or a gNB-CU or a gNB CU-CP or an en-gNB or an eNB or a ng-eNB. In yet other implementations, for example, the seventh node may be a gNB or a gNB-CU or a gNB CU-CP or an en-gNB or an eNB or a ng-eNB, and the eighth node may be an AMF or an SMF or an MME.

Step 801A: the eighth node transmits the reference signal transmission configuration to the seventh node. The reference signal transmission configuration may be the afore-mentioned eighth message. The reference signal transmission configuration may be the transmission configuration for the seventh node or the transmission configuration for the eighth node.

Step 802A: the eighth node can perform measurement and/or update a measurement configuration according to the received reference signal transmission configuration and/or transmit reference signals according to the configuration and the like, so as to reduce unnecessary reference signal measurement and/or unnecessary reference signal transmission and achieve a purpose of energy-saving, etc.

FIG. 8B illustrates a schematic diagram of an aspect of a method for supporting network energy-saving according to embodiments of the present disclosure. Specifically, FIG. 8B shows a process of exchanging reference signal transmission configuration between two nodes, so that the seventh node can perform measurement and/or update a measurement configuration according to the reference signal transmission configuration of the eighth node and/or the seventh node and/or other nodes obtained from the eighth node and/or transmit reference signals according to the configuration, so as to avoid unnecessary reference signal transmission and/or measurement and/or unnecessary reference signal transmission, and/or avoid performance decrease of other nodes due to an energy-saving strategy (for example, a reference signal transmission strategy) made according to local information, and achieve a purpose of energy-saving. In some implementations, for example, the seventh node may be a UE, and the eighth node may be a gNB or a gNB-CU or a gNB-DU or a gNB CU-CP or a gNB CU-UP or an en-gNB or an eNB or a ng-eNB. In some other implementations, for example, the seventh node may be a gNB or a gNB-CU or a gNB-DU or a gNB CU-CP or a gNB CU-UP or an en-gNB or an eNB or a ng-eNB, and the eighth node may be a gNB or a gNB-CU or a gNB-DU or a gNB CU-CP or a gNB CU-UP or an en-gNB or an eNB or a ng-eNB. In yet other implementations, for example, the seventh node may be an AMF or an SMF or an MME, and the eighth node may be a gNB or a gNB-CU or a gNB CU-CP or an en-gNB or an eNB or a ng-eNB. In yet other implementations, for example, the seventh node may be a gNB or a gNB-CU or a gNB CU-CP or an en-gNB or an eNB or a ng-eNB, and the eighth node may be an AMF or an SMF or an MME.

Step 801B: the seventh node transmits a reference signal transmission suggestion to the eighth node. The reference signal transmission suggestion may be the afore-mentioned seventh message. The reference signal transmission suggestion may be a transmission suggestion for the seventh node or a transmission suggestion for the eighth node. The reference signal transmission suggestion may be obtained based on information about measurement relaxation of the UE. For example, the information about measurement relaxation of the UE may be obtained by referring to FIGS. 3A, 3B, 3C, 3D, 4A, 4B, 4C, etc.

Step 802B: the eighth node transmits a reference signal transmission configuration to the seventh node. The reference signal transmission configuration may be the afore-mentioned eighth message. The reference signal transmission configuration may be a transmission configuration for the seventh node or a transmission configuration for the eighth node.

Step 803B: the eighth node may perform measurement and/or update a measurement configuration according to the received reference signal transmission configuration and/or transmit reference signals according to the configuration and the like, and/or transmit reference signals according to the configuration, so as to reduce unnecessary reference signal measurement and/or unnecessary reference signal transmission, and/or avoid performance decrease of other nodes due to an energy-saving strategy (for example, a reference signal transmission strategy) made according to local information, and achieve a purpose of energy-saving.

FIG. 8C illustrates a schematic diagram of an aspect of a method for supporting network energy-saving according to embodiments of the present disclosure. Specifically, FIG. 8C shows a process of exchanging reference signal transmission configuration among a gNB CU1, a gNB CU2 and a gNB DU2 under a split architecture, in which the gNB CUI can suggest, according to its own situation and/or UE's information about measurement relaxation, gNB2 (including gNB CU2 and/or gNB DU2, etc.) to change a reference signal transmission configuration, and the gNB2 (including gNB CU2 and/or gNB DU2, etc.) updates the reference signal transmission configuration according to its own situation after receiving the transmission suggestion of gNB CU1, so as to avoid unnecessary reference signal transmission and achieve a purpose of energy-saving.

Step 801C: the gNB CU1 transmits a reference signal transmission suggestion to the gNB CU2. The reference signal transmission suggestion may be the aforementioned seventh message. The reference signal transmission suggestion may be obtained based on the information about measurement relaxation of the UE. For example, the information about measurement relaxation of the UE can be obtained by referring to FIGS. 3A, 3B, 3C, 3D, 4A, 4B, 4C, etc.

Step 802C: the gNB CU2 transmits a reference signal transmission suggestion to the gNB DU2. The reference signal transmission suggestion may be the aforementioned seventh message.

Step 803C: the gNB DU2 may update a reference signal transmission configuration according to the received reference signal transmission suggestion, and transmit the reference signal transmission configuration to the gNB CU2. The reference signal transmission configuration may be the aforementioned eighth message.

Step 804C: the gNB CU2 transmits the reference signal transmission configuration to the gNB CU1. The reference signal transmission configuration may be the afore-mentioned eighth message.

Step 805C: the gNB CU1 may perform measurement and/or update a measurement configuration according to the received reference signal transmission configuration, so as to reduce unnecessary reference signal measurement, etc.

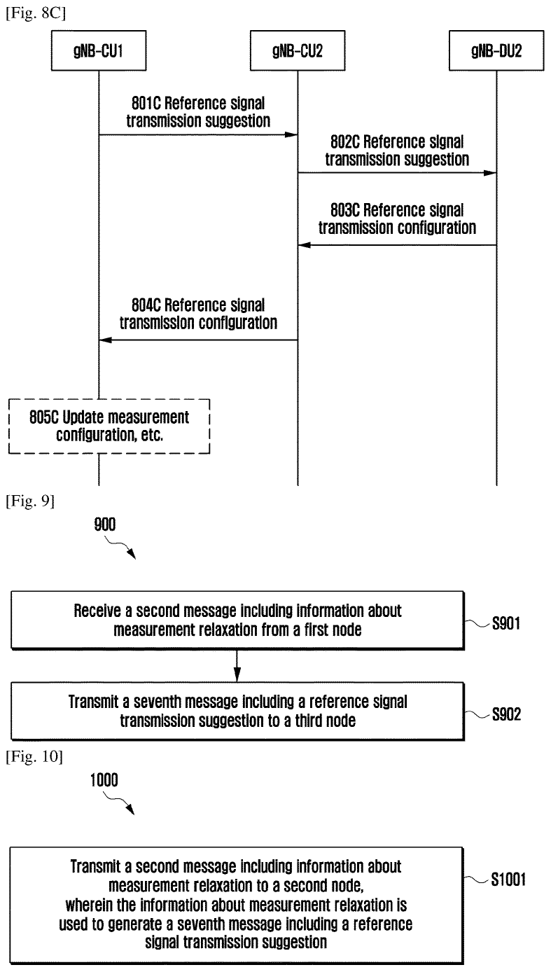

Next, FIG. 9 illustrates a flowchart of a method 900 performed by a second node in a wireless communication system according to embodiments of the present disclosure.

As shown in FIG. 9, a method 900 performed by a second node in a wireless communication system according to embodiments of the present disclosure may include: in step S901, receiving a second message including information about measurement relaxation from a first node; and in step S902, transmitting a seventh message including a reference signal transmission suggestion to a third node. In some implementations, as described above, the first node may be a UE, the second node may be a gNB, and the third node may be a neighboring node of the second node. In addition, any one of the first node, the second node and the third node described herein may be any one of various nodes described above in connection with various examples and drawings.

Additionally or alternatively, the method 900 may further include: transmitting a first message including a request for the information about measurement relaxation to the first node.

Additionally or alternatively, the method 900 may further include: transmitting a third message including a configuration about measurement relaxation to the first node. In some implementations, the configuration about measurement relaxation may be configured based on the information about measurement relaxation.

Additionally or alternatively, the method 900 may further include: receiving a fifth message including handover time information of a target node from a fourth node. As mentioned above, the fourth node herein may be a target node for handover as mentioned above, or any other node capable of obtaining handover time information of the target node and the like.

Additionally or alternatively, the method 900 may further include: transmitting a fourth message including handover time information of a source node to the fourth node. Herein, the second node may be a source node for handover, or the second node may obtain handover time information of a source node for handover.

Additionally or alternatively, the method 900 may further include: transmitting a radio resource control reconfiguration message to the first node based on the handover time information of a target node.

Additionally or alternatively, the method 900 may further include: transmitting a sixth message including handover configuration effective information to the first node. In some implementations, the handover configuration effective information may be received by the second node from the fourth node.

Additionally or alternatively, the method 900 may further include: receiving an eighth message including a reference information transmission configuration from the third node. In some implementations, a reference signal transmission suggestion may be determined based on information about measurement relaxation.

Additionally or alternatively, the method 900 may further include: making a network self-optimization decision based on at least one message described above. In some implementations, the network self-optimization decision may include at least one of network energy-saving, load balancing, coverage optimization, mobility optimization and/or management, network configuration determination and/or network configuration update, etc.

FIG. 10 illustrates a flowchart of a method 1000 performed by a first node in a wireless communication system according to embodiments of the present disclosure.

As shown in FIG. 10, a method 1000 performed by a first node in a wireless communication system according to embodiments of the present disclosure may include transmitting a second message including information about measurement relaxation to a second node in step S1001. As described above, in some implementations, the message about measurement relaxation may be used to generate a seventh message including a reference signal transmission suggestion.

Additionally or alternatively, the method 1000 may further include: receiving a first message including a request for information about measurement relaxation from a second node.

Additionally or alternatively, the method 1000 may further include: receiving a third message including a configuration about measurement relaxation from the second node. In some implementations, the configuration about measurement relaxation may be configured based on the information about measurement relaxation.

Additionally or alternatively, the method 1000 may further include: receiving a radio resource control reconfiguration message from the second node. In some implementations, the radio resource control reconfiguration message may be transmitted by the second node based on handover time information of a target node as described above.

Additionally or alternatively, the method 1000 may further include: receiving a sixth message including handover configuration effective information from the second node. In some implementations, as mentioned above, the handover configuration effective information may be received by the second node from the fourth node, or may be determined by the second node itself based on one or more pieces of energy-saving related information (for example, handover time information of a source side and/or handover time information of a target side).

The methods 900, 1000 and various steps in various examples and drawings according to embodiments of the present disclosure as described above may be performed individually or jointly in any combination, and may be performed in any order, for example, simultaneously or in a reverse order of the listed order.

The first to eighth messages described herein may be or include the corresponding messages described above in connection with specific examples.

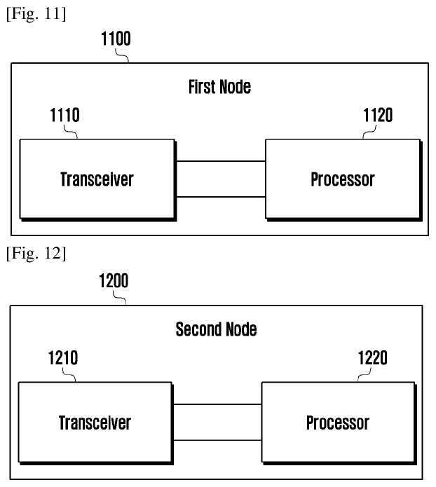

Next, FIG. 11 illustrates a schematic diagram of a first node 1100 according to embodiments of the present disclosure.

As shown in FIG. 11, a first node (or may be referred to as a first node device) 1100 according to embodiments of the present disclosure may include a transceiver 1110 and a processor 1120. The transceiver 1110 may be configured to transmit and receive signals. The processor 1120 may be coupled with the transceiver 1110 and may be configured to (e.g., control the transceiver 1110 to) perform the methods performed by a first node according to embodiments of the present disclosure.

FIG. 12 illustrates a schematic diagram of a second node 1200 according to embodiments of the present disclosure.

As shown in FIG. 12, a second node (or may be referred to as a second node device) 1200 according to embodiments of the present disclosure may include a transceiver 1210 and a processor 1220. The transceiver 1210 may be configured to transmit and receive signals. The processor 1220 may be coupled with the transceiver 1210 and may be configured to (e.g., control the transceiver 1210 to) perform the methods performed by a second node according to embodiments of the present disclosure. Herein, a processor may also be called a controller.

Embodiments of the present disclosure also provide a computer-readable medium having computer-readable instructions stored thereon, which, when executed by a processor, can be used to implement any method according to embodiments of the present disclosure.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method by a terminal in a wireless communication system, the method comprising:
receiving, from a source base station, a configuration message including an execution condition for the conditional handover, the execution condition being associated with an energy saving mode of the source base station;
identifying whether the execution condition is satisfied based on the configuration message; and
in case that the execution condition is satisfied, performing the conditional handover to a target base station.

2. The method of claim 1, wherein the execution condition being as-sociated with the energy saving mode of the source base station is satisfied, in case that information that the source base station is to enter the energy saving mode is received.

3. The method of claim 1, wherein the configuration message further includes at least one of transmitting node identification, receiving node identification, applicable scope, effective validity time of the execution condition, or effective validity time of the configuration.

4. The method of claim 3, wherein the conditional handover to the target base station is performed, in case that effective validity time of the execution condition and effective validity time of the configuration are satisfied.

5. The method of claim 1, wherein the configuration message includes a HANDOVER COMMAND message, and wherein the source base station and the target base station include a gNBs, and the terminal includes a user equipment (UE).

6. A method by a source base station in a wireless communication system, the method comprising:
transmitting, to a terminal, a configuration message including an execution condition for the conditional handover, the execution condition being associated with an energy saving mode of the source base station;
identifying whether the source base station is to enter the energy saving mode; and
in case that the source base station is to enter the energy saving mode, transmitting, to the terminal, information that the source base station is to enter the energy saving mode, the information being for the conditional handover of the terminal.

7. The method of claim 6, wherein the configuration message further includes at least one of transmitting node identification, receiving node identification, applicable scope, effective validity time of the execution condition, or effective validity time of the configuration, and wherein the conditional handover of the terminal to a target base station is performed, in case that effective validity time of the execution condition and effective validity time of the configuration are satisfied.

8. A terminal in a wireless communication system, comprising:
a transceiver; and
a controller configured to control to:
receive, from a source base station, a configuration message including an execution condition for the conditional handover, the execution condition being associated with an energy saving mode of the source base station,
identify whether the execution condition is satisfied based on the configuration message, and
in case that the execution condition is satisfied, perform the conditional handover to a target base station.

9. The terminal of claim 8, wherein the execution condition being as-sociated with the energy saving mode of the source base station is satisfied, in case that information that the source base station is to enter the energy saving mode is received.

10. The terminal of claim 8, wherein the configuration message further includes at least one of transmitting node identification, receiving node identification, applicable scope, effective validity time of the execution condition, or effective validity time of the configuration.

11. The terminal of claim 10, wherein the conditional handover to the target base station is performed, in case that effective validity time of the execution condition and effective validity time of the configuration are satisfied.

12. The terminal of claim 8, wherein the configuration message includes a HANDOVER COMMAND message, and wherein the source base station and the target base station include a gNBs, and the terminal includes a user equipment (UE).

13. A source base station in a wireless communication system, comprising:
a transceiver; and
a controller configured to control to:
transmit, to a terminal, a configuration message including an execution condition for the conditional handover, the execution condition being associated with an energy saving mode of the source base station, identify whether the source base station is to enter the energy saving mode, and
in case that the source base station is to enter the energy saving mode, transmit, to the terminal, information that the source base station is to enter the energy saving mode, the information being for the conditional handover of the terminal.

14. The source base station of claim 13, wherein the configuration message further includes at least one of transmitting node identification, receiving node identification, applicable scope, effective validity time of the execution condition, or effective validity time of the configuration, and
wherein the conditional handover of the terminal to a target base station is performed, in case that effective validity time of the execution condition and effective validity time of the configuration are satisfied.
